(19) United States
(12) Patent Application Publication
(10) Pub. No.: US 2016/0204908 A1
(43) Pub. Date: Jul. 14, 2016

(54) ADAPTIVE MULTI-RATE PARTIAL DECODE

(71) Applicant: QUALCOMM Incorporated, San Diego, CA (US)

(72) Inventors: Hassan Rafique, Farnborough (GB); Divaydeep Sikri, Woking (GB); Mukund Agarwal, Farnborough (GB); Jafar Mohseni, San Diego, CA (US); Srikanth Kodali, Woking (GB)

(21) Appl. No.: 14/596,602

(22) Filed: Jan. 14, 2015

(51) Int. Cl. H04L 1/20; H04W 24/08

(52) U.S. Cl. CPC H04L 1/203; H04W 24/08

(57) ABSTRACT

Aspects of the disclosure are directed to a method, apparatus, and computer software for wireless communication. In various examples, a method of wireless communication performed by a user equipment (UE) includes measuring channel quality over a measurement period associated with a voice call corresponding to a first subscription supported by the user equipment, determining whether the channel quality is sufficient to enable an adaptive multi-rate (AMR) decoder to ignore one or more bursts of a plurality of bursts carrying a block of data received at the user equipment, and causing the adaptive multi-rate decoder to decode the block of data without the one or more bursts when the channel quality is determined to be sufficient to enable the adaptive multi-rate decoder to ignore the one or more bursts. The channel quality may be measured by measuring a bit error rate for a transmission on a slow associated control channel (SACCH).

### TECHNICAL FIELD

Aspects of the present disclosure relate generally to wireless communication systems, and more particularly, to discontinuous transmission and reception.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). As the demand for mobile broadband access continues to increase, research and development continue to advance the UMTS technologies not only to meet the growing demand for mobile broadband access, but to advance and enhance the user experience with mobile communications.

Generally, a transmitter or receiver in a battery-powered wireless communication device may be powered-on to facilitate communication, such as a circuit-switched voice call. However, powering-on a transmitter or receiver can have a detrimental impact on battery-life in battery-powered application environments. Modifications to conventional communication techniques are needed in order to reduce power consumption and/or to improve coexistence issues associated with multiple subscriptions maintained by the wireless communication device.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method of wireless communication. The method may be performed by a user equipment (UE) and may include measuring channel quality over a measurement period associated with a voice call corresponding to a first subscription supported by the user equipment, determining whether the channel quality is sufficient to enable an adaptive multi-rate (AMR) decoder to ignore one or more bursts of a plurality of bursts carrying a block of data received at the user equipment, and causing the adaptive multi-rate decoder to decode the block of data without the one or more bursts when the channel quality is determined to be sufficient to enable the adaptive multi-rate decoder to ignore the one or more bursts.

In another aspect, the channel quality may be measured by measuring a bit error rate for a transmission on a slow associated control channel (SACCH). The transmission on the SACCH may include one or more signaling messages. The bit error rate may be expressed as an average bit error rate. The channel quality may be expressed as a lowest channel quality for a predetermined number of blocks transmitted during the measurement period.

In another aspect, decoding the block of data without using the one or more bursts includes determining whether minimum channel quality during the measurement period exceeds a predefined minimum quality, establishing whether receive power associated with the voice call exceeds a predefined minimum power level, and ignoring the one or more bursts when the minimum channel quality exceeds the predefined minimum quality and the receive power exceeds the predefined minimum power level.

In another aspect, the adaptive multi-rate decoder may include the one or more bursts while decoding the block of data when a received one of the plurality of bursts fails a cyclic redundancy check.

In another aspect, it may be determined that a signal-to-noise ratio (SNR) associated with a first portion of the plurality of bursts exceeds a predefined minimum threshold, and the adaptive multi-rate decoder may refrain from receiving a second portion of the plurality of bursts when the SNR exceeds the predefined minimum threshold. A codec may be selected for decoding the block of data from a set of available codecs based on the SNR. A mode of operation of the codec used for decoding the block of data may be selected based on the SNR. A number of bursts in the second portion of the plurality of bursts may be selected based on the SNR.

In another aspect, it may be determined that a SNR associated with a first portion of the plurality of bursts exceeds a predefined minimum threshold, and the SNR may be used to index a table maintained by the user equipment in order to select a number of bursts to be included in the one or more bursts. The block of data may be decoded using a codec and a characteristic of the codec may be the select the number of bursts to be included in the one or more bursts.

In one aspect, the disclosure provides a UE that has a transceiver configured to communicate over a radio frequency (RF) channel, at least one subscriber identity module (SIM), an adaptive multi-rate decoder, and at least one processing circuit. The UE may be adapted to support a dual SIM dual active mode of operation. The at least one processing circuit may be configured to measure channel quality over a measurement period associated with a voice call corresponding to a first subscription supported by the user equipment, and determine whether the channel quality is sufficient to enable the adaptive multi-rate decoder to ignore one or more bursts of a plurality of bursts carrying a block of data received at the user equipment. The adaptive multi-rate decoder may be configured or adapted to permit decoding of the block of data without the one or more bursts when the channel quality is determined to be sufficient to enable the adaptive multi-rate decoder to ignore the one or more bursts.

In another aspect, the at least one processing circuit may be configured to measure the channel quality as a bit error rate for a transmission on a control channel. The transmission on the control channel may include one or more signaling messages. The bit error rate may be expressed as an average bit error rate. Measurements of channel quality may include a measurement of lowest channel quality for a predetermined number of blocks transmitted during the measurement period.

In another aspect, at least one processing circuit is configured to determine whether minimum channel quality during the measurement period exceeds a predefined minimum quality, and establish whether receive power associated with the voice call exceeds a predefined minimum power level. The adaptive multi-rate decoder may ignore the one or more bursts for the purpose of decoding the block of data when the minimum channel quality exceeds the predefined minimum quality and the receive power exceeds the predefined minimum power level. The adaptive multi-rate decoder includes the one or more bursts while decoding the block of data when a received one of the plurality of bursts fails a cyclic redundancy check.

In another aspect, the at least one processing circuit may be configured to determine that a SNR associated with a first portion of the plurality of bursts exceeds a predefined minimum threshold, and refrain from receiving a second portion of the plurality of bursts when the SNR exceeds the predefined minimum threshold. The at least one processing circuit may be configured to select a codec for decoding the block of data from a set of available codecs based on the SNR. The at least one processing circuit may configure a mode of operation of a codec used for decoding the block of data based on the SNR. The at least one processing circuit may be configured to select a number of bursts in the second portion of the plurality of bursts based on the SNR.

In another aspect, the at least one processing circuit may be configured to determine that the SNR associated with a first portion of the plurality of bursts exceeds a predefined minimum threshold, and use the SNR to index a table maintained by the user equipment in order to select a number of bursts to be included in the one or more bursts. The UE may employ a codec adapted to decode the block of data and the at least one processing circuit may be configured to select the number of bursts to be included in the one or more bursts based on a characteristic of the codec.

In one aspect, an apparatus includes a transceiver configured to communicate over an RF channel, one or more SIMs, means for the measuring RF channel quality during a measurement period associated with a voice call corresponding to a first subscription supported by the user equipment, means for determining whether the RF channel quality is sufficient to enable an adaptive multi-rate decoder to ignore one or more bursts of a plurality of bursts carrying a block of data received at the user equipment, and means for causing the adaptive multi-rate decoder to decode the block of data without the one or more bursts when the channel quality is determined to be sufficient to enable the adaptive multi-rate decoder to ignore the one or more bursts.

In one aspect, a computer-readable medium stores and/or maintains instructions. The computer-readable medium may include transitory and/or non-transitory storage media. The instructions when executed by a processing circuit may cause the processing circuit to measure channel quality over a measurement period associated with a voice call corresponding to a first subscription supported by the user equipment, determine whether the channel quality is sufficient to enable an adaptive multi-rate decoder to ignore one or more bursts of a plurality of bursts carrying a block of data received at the user equipment, and cause the adaptive multi-rate decoder to decode the block of data without the one or more bursts when the channel quality is determined to be sufficient to enable the adaptive multi-rate decoder to ignore the one or more bursts.

### BRIEF DESCRIPTION OF THE DRAWINGS

FIG. 1 is a block diagram illustrating an example of a hardware implementation for an apparatus employing a processing system.

FIG. 2 is a block diagram conceptually illustrating an example of a telecommunications system.

FIG. 3 is a conceptual diagram illustrating an example of an access network.

FIG. 4 is a conceptual diagram illustrating an example of a radio protocol architecture for the user and control plane.

FIG. 5 is a block diagram conceptually illustrating an example of a Node B in communication with a user equipment (UE) in a telecommunications system.

FIG. 6 is a conceptual diagram of a circuit-switched (CS) Voice transmission on a dedicated channel (DCH) using a 20 ms transmission time interval (TTI).

FIG. 7 is a conceptual diagram of a CS Voice transmission on DCH using a portion of the TTI of FIG. 6.

FIG. 8 is a block diagram illustrating a device that supports multiple subscriber identity modules (SIMs).

FIGS. 9-12 illustrate the impact of channel quality on loss observed when blind AMR partial decode (AMR-PD) is employed.

FIGS. 13-16 illustrate the robustness of signaling messages to partial decode.

FIG. 17 illustrates the decoding of blocks from a sequence of received bursts.

FIGS. 18 and 19 illustrate operating conditions affecting certain examples of codec.

FIG. 20 is a flowchart illustrating a method for managing AMR_PD in a UE.

FIG. 21 includes charts and that plot BER against average SNR

FIG. 22 illustrates an example of a table that may be maintained by a UE to configure AMR-PD

FIG. 23 is a flowchart illustrating a process executed in lower levels of the protocol stack in order to control the operation of AMR-PD.

FIGS. 24-26 illustrate certain characteristics of an Adaptive Full-Rate Speech (AFS) codec.

FIG. 27 illustrates certain operational aspects of AMR-PD.

FIG. 28 illustrates certain operational aspects of AMR-PD related to fast associated control channel.

FIG. 29 illustrates a simplified example of a hardware implementation for an apparatus employing a processing circuit that may be configured to perform one or more functions disclosed herein.

FIG. 30 is a flow chart of an exemplary method of wireless communication for AMR-PD according to certain aspects disclosed herein.

FIG. 31 is a diagram illustrating a simplified example of a hardware implementation for AMR-PD according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Aspects of the disclosure are directed to downlink (DL) and uplink (UL) discontinuous reception (DRX) and discontinuous transmission (DTX). For example, DTX may be used in a circuit-switched environment to support voice calls. DTX may provide for power savings relative to a continuous transmission.

Currently, circuit-switched calls utilize a 20 ms transmission time interval (TTI). Aspects of the disclosure may be used to reduce the TTI that is effectively used. For example, a voice packet may be available for transmission at the start of a 20 ms TTI window, but the actual transmission of that packet might not span or consume the entire TTI window, such that the packet only consumes a portion of the TTI window when transmitted. In this case, the transmitting device may suspend its transmission for a portion of the TTI window. For example, the portion of the TTI window may correspond to half of the entire TTI window. During a second portion or a remainder of the TTI window that is not consumed by a transmission of voice packets, a transmitter and/or receiver may suspend, power-down, or turn-off, thereby enabling power savings. In some instances, one or more dedicated physical control channel (DPCCH) parameters are transmitted on a pre-determined number of slots during the remainder of the TTI prior to the start of a next TTI.

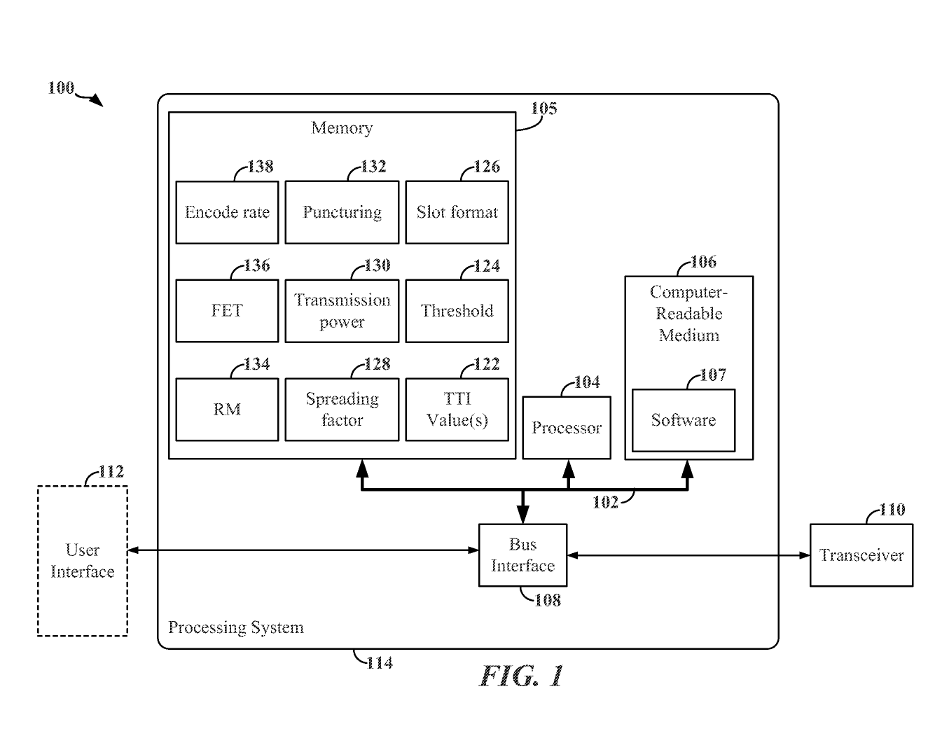

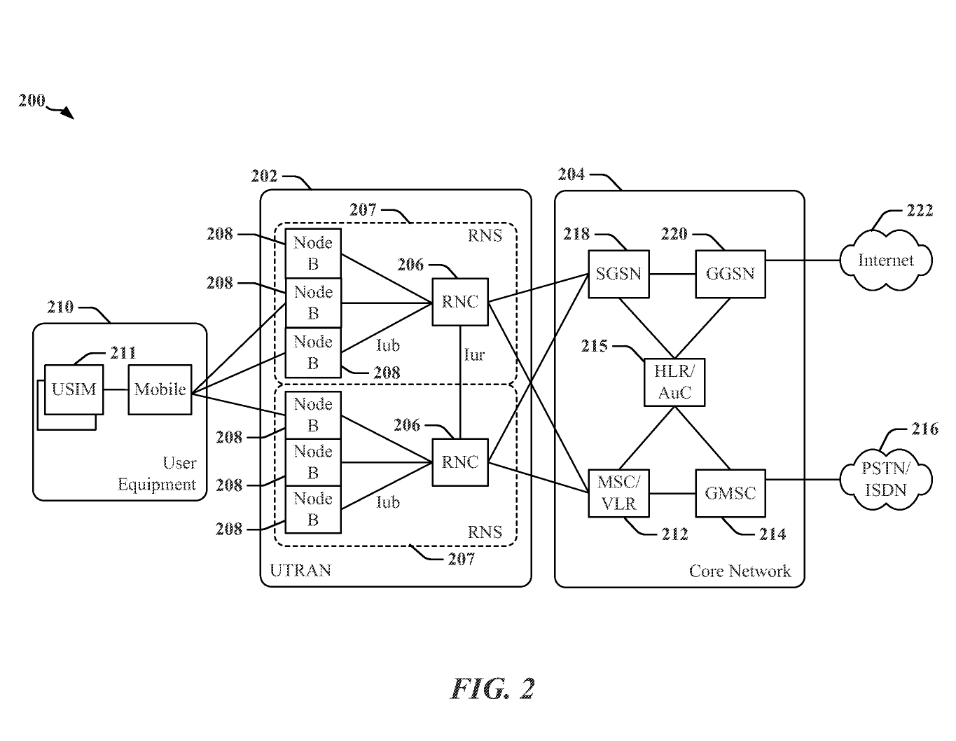

FIG. 1 is a conceptual diagram illustrating an example of a hardware implementation for an apparatus 100 employing a processing system 114. In accordance with various aspects of the disclosure, an element, or any portion of an element, or any combination of elements may be implemented with a processing system 114 that includes one or more processors 104. For example, the apparatus 100 may be a user equipment (UE) as illustrated in any one or more of FIGS. 2, 3, and 5. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus 100, a user interface 112 (e.g., keypad, display, speaker, microphone, joystick) may also be provided.

As shown in FIG. 1, one or more transmission time interval (TTI) parameters or values 122 may be stored in the memory 105. The TTI values 122 may correspond to the entirety or portions of a TTI or TTI window. For example, a first value 122 may correspond to 10 ms or half a TTI window, where the TTI window may be 20 ms and selected for a circuit-switched voice call. Of course, any suitable value or values may be stored as the TTI value(s) 122. The processor 104 may be operative on the basis of one or more TTI values 122 to enable discontinuous transmission (DTX) and discontinuous reception (DRX) operations during a circuit-switched voice call. For example, where the first TTI value 122 is half the TTI window, use of the first TTI value 122 may entail transmission or reception of voice frames on alternate portions of the entire TTI window. The memory 105 is shown as including a number of additional parameters or values 124-138. The parameters 124-138 are referenced here as a prelude to a more detailed description of their role and function below.

The processor 104 is responsible for managing the bus 102 and general processing, including the execution of software 107 stored on the computer-readable medium 106. The software 107, when executed by the processor 104, causes the processing system 114 to perform the various functions described below for any particular apparatus. The computer-readable medium 106 may also be used for storing data that is manipulated by the processor 104 when executing software. In accordance with aspects of the disclosure, the software 107 may be included in the memory 105.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The various concepts presented throughout this disclosure may be implemented across a broad variety of telecommunication systems, network architectures, and communication standards. Referring now to FIG. 2, as an illustrative example without limitation, various aspects of the present disclosure are illustrated with reference to a Universal Mobile Telecommunications System (UMTS) system 200. A UMTS network includes three interacting domains: a core network 204, a radio access network (RAN) (e.g., the UMTS Terrestrial Radio Access Network (UTRAN) 202), and a user equipment (UE) 210. Among several options available for a UTRAN 202, in this example, the illustrated UTRAN 202 may employ a W-CDMA air interface for enabling various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The core network 204 can interface with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-switched data services with a serving GPRS support node (SGSN) 218 and a gateway GPRS support node (GGSN) 220. General Packet Radio Service (GPRS) is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

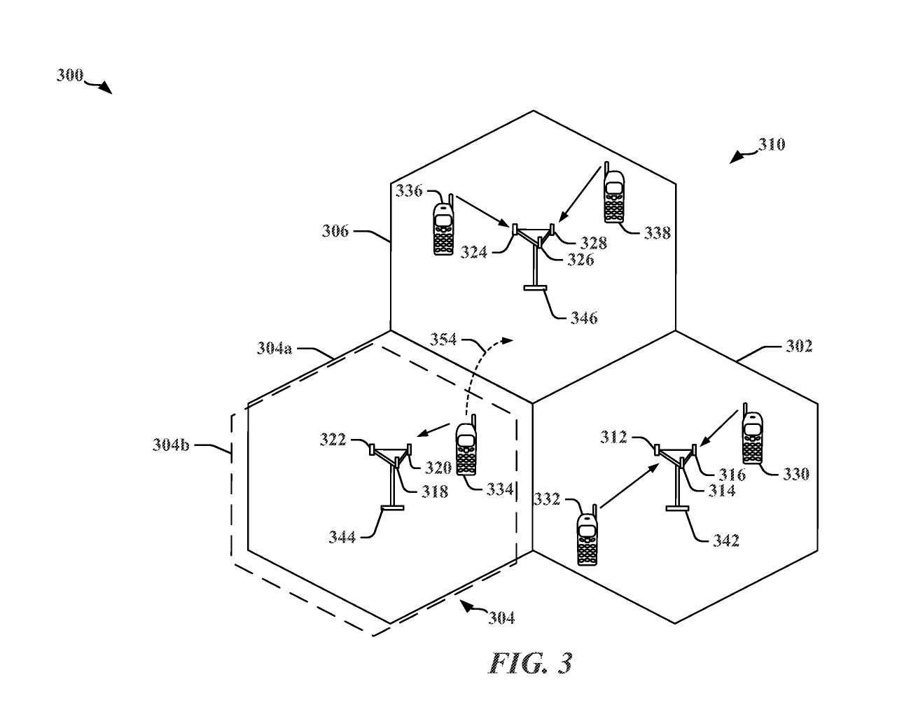

The UTRAN 202 is one example of a RAN that may be utilized in accordance with the present disclosure. Referring to FIG. 3, by way of example and without limitation, a simplified schematic illustration of a RAN 300 in a UTRAN architecture is illustrated. The system includes multiple cellular regions (cells), including cells 302, 304, and 306, each of which may include one or more sectors. Cells may be defined geographically (e.g., by coverage area) and/or may be defined in accordance with a frequency, scrambling code, etc. That is, the illustrated geographically-defined cells 302, 304, and 306 may each be further divided into a plurality of cells, e.g., by utilizing different scrambling codes. For example, cell 304a may utilize a first scrambling code, and cell 304b, while in the same geographic region and served by the same Node B 344, may be distinguished by utilizing a second scrambling code.

In a cell that is divided into sectors, the multiple sectors within a cell can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 may each correspond to a different sector. In cell 306, antenna groups 324, 326, and 328 may each correspond to a different sector.

The cells 302, 304, and 306 may include several UEs that may be in communication with one or more sectors of each cell 302, 304, or 306. For example, UEs 330 and 332 may be in communication with Node B 342, UEs 334 and 336 may be in communication with Node B 344, and UEs 338 and 340 may be in communication with Node B 346. Here, each Node B 342, 344, and 346 may be configured to provide an access point to a core network 204 (see FIG. 2) for all the UEs 330, 332, 334, 336, 338, and 340 in the respective cells 302, 304, and 306.

During a call with a source cell, or at any other time, the UE 336 may monitor various parameters of the source cell as well as various parameters of neighboring cells. Further, depending on the quality of these parameters, the UE 336 may maintain communication with one or more of the neighboring cells. During this time, the UE 336 may maintain an Active Set, that is, a list of cells to which the UE 336 is simultaneously connected (i.e., the UTRAN cells that are currently assigning a downlink dedicated physical channel (DPCH) or fractional downlink dedicated physical channel (F-DPCH) to the UE 336 may constitute the Active Set).

The UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. The W-CDMA air interface for the UTRAN 202 is based on such DS-CDMA technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface or any other suitable air interface.

In a wireless telecommunication system, the communication protocol architecture may take on various forms depending on the particular application. For example, in a 3GPP UMTS system, the signaling protocol stack is divided into a Non-Access Stratum (NAS) and an Access Stratum (AS). The NAS provides the upper layers, for signaling between the UE 210 and the core network 204 (referring to FIG. 2), and may include circuit-switched and packet switched protocols. The AS provides the lower layers, for signaling between the UTRAN 202 and the UE 210, and may include a user plane and a control plane. Here, the user plane or data plane carries user traffic, while the control plane carries control information (i.e., signaling).

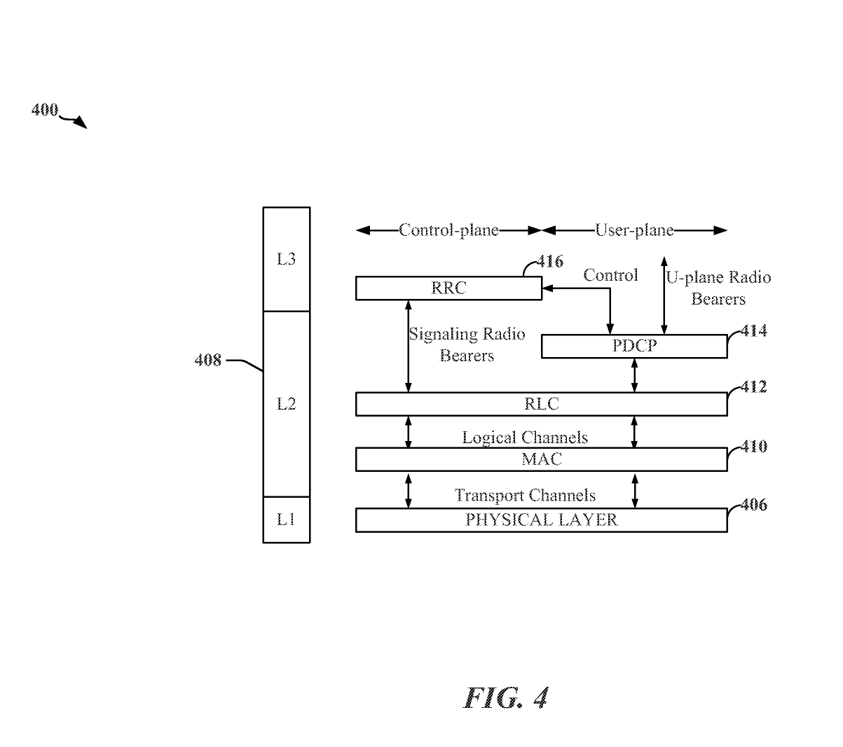

Turning to FIG. 4, the AS is shown with three layers: Layer 1, Layer 2, and Layer 3. Layer 1 is the lowest layer and implements various physical layer signal processing functions. Layer 1 will be referred to herein as the physical layer 406. The data link layer, called Layer 2 408, is above the physical layer 406 and is responsible for the link between the UE 210 and Node B 208 over the physical layer 406.

At Layer 3, the RRC layer 416 handles the control plane signaling between the UE 210 and the Node B 208. RRC layer 416 includes a number of functional entities for routing higher layer messages, handling broadcasting and paging functions, establishing and configuring radio bearers, etc.

In the illustrated air interface, the L2 layer 408 is split into sublayers. In the control plane, the L2 layer 408 includes two sublayers: a medium access control (MAC) sublayer 410 and a radio link control (RLC) sublayer 412. In the user plane, the L2 layer 408 additionally includes a packet data convergence protocol (PDCP) sublayer 414. Although not shown, the UE may have several upper layers above the L2 layer 408 including a network layer (e.g., IP layer) that is terminated at a PDN gateway on the network side and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between Node Bs.

The RLC sublayer 412 generally supports an acknowledged mode (AM) (where an acknowledgment and retransmission process may be used for error correction), an unacknowledged mode (UM), and a transparent mode for data transfers, and provides segmentation and reassembly of upper layer data packets and reordering of data packets to compensate for out-of-order reception due to a hybrid automatic repeat request (HARQ) at the MAC layer. In the acknowledged mode, RLC peer entities such as an RNC and a UE may exchange various RLC protocol data units (PDUs) including RLC Data PDUs, RLC Status PDUs, and RLC Reset PDUs, among others. In the present disclosure, the term “packet” may refer to any RLC PDU exchanged between RLC peer entities.

The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

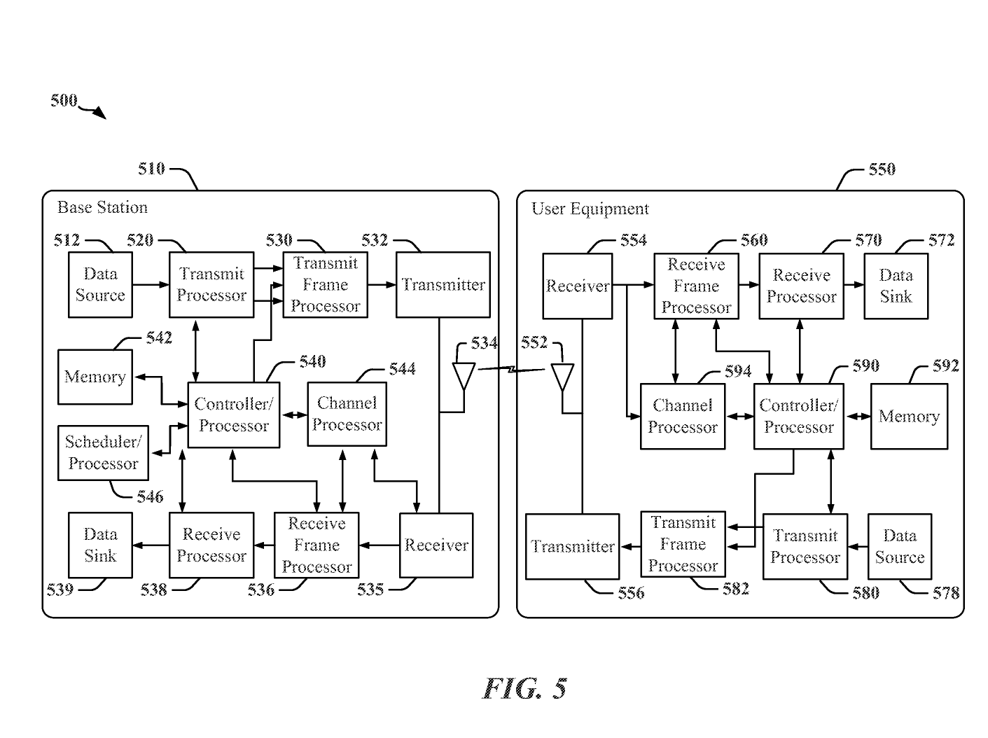

FIG. 5 is a block diagram of an exemplary Node B 510 in communication with an exemplary UE 550, where the Node B 510 may be the Node B 208 in FIG. 2, and the UE 550 may be the UE 210 in FIG. 2. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Having just described various types of systems and apparatuses, attention is now turned to different types of functions, algorithms, and structures that may be employed in connection with such systems and apparatuses. In this era of complex smartphone devices and applications, an optimization of UE battery life may enhance a smartphone user experience. Circuit-switched (CS) voice service, transmitted on dedicated channels such as the uplink or downlink dedicated physical channel (DPCH), continues to remain an important application for the end user in UMTS networks. However, CS voice service consumes a fair amount of UE modem transceiver current when compared to 2G cellular technologies (e.g., GSM).

One technique or method to achieve UE modem current savings is to introduce discontinuous transmissions (DTX) on both the downlink and uplink, which will be familiar to those of ordinary skill in the art. Broadly, DTX operations provide for the periodic or intermittent shutting down of one or more power-consuming portions of a transceiver (e.g., including but not limited to amplifier circuitry within the transmitter 556). However, DTX operations could potentially lead to a link efficiency impact as well as an uplink link budget impact.

A physical layer, such as the physical layer 406 of FIG. 4, may be used to transmit and receive configurations available in UMTS to support DTX of CS voice calls. In some instances, the CS voice calls may be provided using an adaptive multi-rate (AMR) 12.2 kbps CS voice codec on dedicated channels. In certain circuit-switched voice calls in UMTS, a multi-rate speech codec is used, which may be an AMR codec. Details of the operation of the AMR codec are well-known to those of ordinary skill in the art, and are accordingly omitted from the present disclosure. One aspect of the AMR codec is that, during the rearrangement and encoding of bits corresponding to the voice data, the bits are sorted according to their sensitivity to errors, and are accordingly separated into three classes of importance corresponding to error sensitivity: class A, class B, and class C. Class A is the most sensitive to errors, and therefore, in a certain codecs, class A bits are subject to the strongest channel coding. Certain aspects disclosed herein may relate to an AMR 12.2 kbps CS voice codec and/or other codecs such as AMR 5.9 kbps or enhanced voice service (EVS).

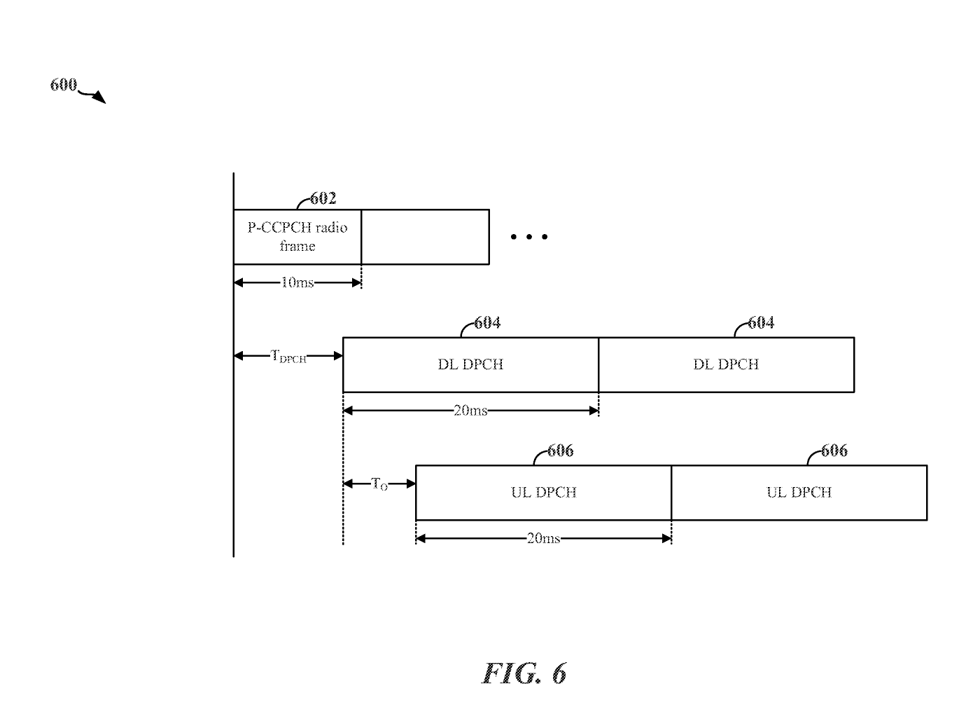

FIG. 6 is a timing diagram that illustrates a transmission format for AMR 12.2 kbps circuit-switched voice transmissions on the DPCH using a 20 ms TTI. Note that when a signalling message is also transmitted, it is encoded and time division multiplexed with the encoded circuit-switched voice frames, and spans a 40 ms TTI (not shown in FIG. 6 for sake of simplicity).

As shown in FIG. 6, a Primary Common Control Physical Channel (P-CCPCH) radio frame 602 may be transmitted using a 10 ms TTI. The P-CCPCH generally carries broadcast information, including the broadcast channel (BCH), which contains information that UEs (e.g., UEs of FIGS. 2, 3, and 5) use for accessing the system. While a single P-CCPCH radio frame 602 is shown, more than one such frame may be transmitted. Downlink (DL) DPCH packets 604 and uplink (UL) DPCH packets 606 may utilize a 20 ms TTI. As shown, the start of the first or leftmost DL DPCH packet 604 may be offset from the start of the P-CCPCH radio frame 602 by a time T_{DPCH}. Similarly, the start of the first or leftmost UL DPCH packet 606 may be offset from the start of the first DL DPCH packet 604 by a time Tₒ, which may be equal to 1024 chips.

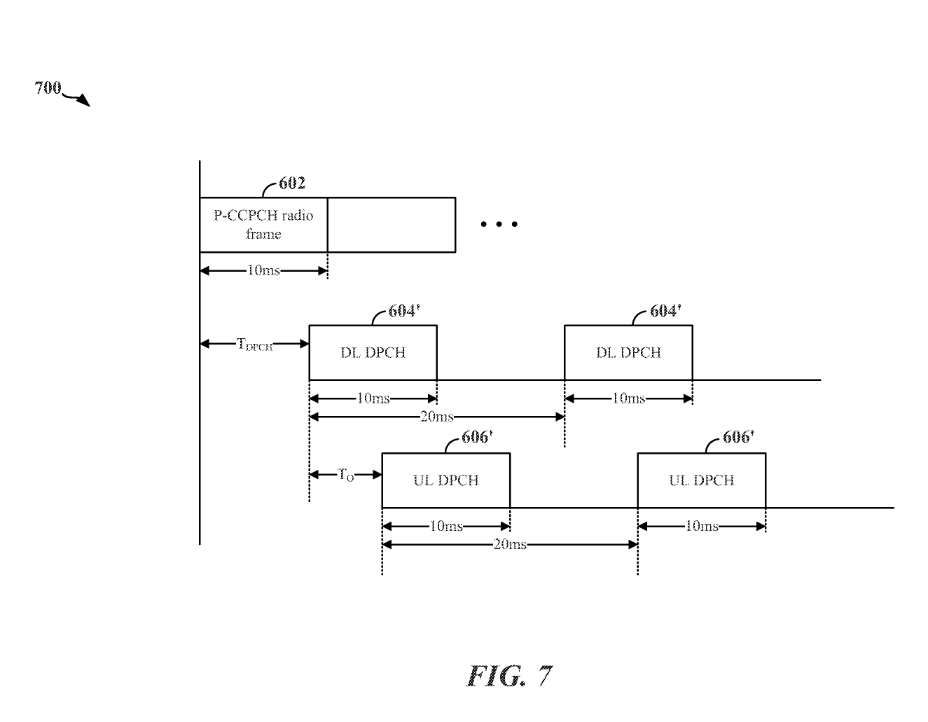

In some instances, UE battery power consumption may be reduced by shortening transmission and reception at the UE (e.g., UE 550) through the introduction of discontinuous transmissions as shown in FIG. 7. In the example 700 illustrated in FIG. 7, voice packets on both uplink (UL) 606′ and downlink (DL) 604′ are generated every 20 ms at the voice codec, but are transmitted over the air using a 10 ms TTI. In other words, during the first portion (e.g., the first 10 ms) of the entire 20 ms TTI window a transmission of voice packets may occur and during the second portion or remainder (e.g., the second 10 ms) of the entire 20 ms TTI window a transmission of voice packets might not occur, such that a transmission of voice packets may be suspended during this second portion or remainder. Here, suspending the transmission of voice packets may include temporarily discontinuing (e.g., gating or turning off) the transmission of the voice packets. The suspension of the transmission may be accomplished in various examples by depowering one or more components or portions of the transceiver 110 (see FIG. 1), or one or more components or portions of the UE 550 including but not limited to the transmitter 556 (or sub-components of the transmitter 556 such as a power amplifier). In general, the transmission may take place during the initial portion of the TTI window, although this is not necessarily the case. Broadly, the portion of the TTI window during which the transmission takes place may be referred to as a first portion of the TTI, while the portion of the TTI window during which the transmission is suspended may be referred to as a second portion or remainder of the TTI. That is, in an example where the transmission takes place during the initial portion of the TTI window, the second portion or remainder of the TTI may extend from the end of the transmission until the end of the TTI window. In an example where the transmission takes place during any portion other than the initial portion of the TTI window, the second portion or remainder of the TTI may include part of the TTI window prior to and after the first portion, broadly including all of the TTI window exclusive of the portion of the TTI window during which the transmission takes place. In this manner, the UE transmitter 556 can be gated, e.g., 50% of the time leading to a significant UE modem current savings.

In a DTX configuration, where voice packets or frames are transmitted utilizing only a portion of a TTI and transmission is suspended for the remainder of the TTI, the instantaneous transmitter power may be increased relative to a non-DTX configuration in which the entirety of the TTI is used for the transmission of packets. For example, during DTX operations the instantaneous transmit power might be increased to maintain a desired call quality or reliability of the transmission. However, if the incremental power is not available, then according to certain aspects a “fall back” to operation that utilizes the entirety of the TTI may occur. For example, if transmitter power is headroom limited, operation may fall back from a DTX configuration consuming a portion of a TTI window to a non-DTX configuration consuming the entirety of, or substantially all of the TTI window. In this respect, a changing, or dynamic switching between DTX and non-DTX configurations may be provided. Available power (e.g., as provided by a transmission power parameter 130, which may correspond to a power headroom, stored in memory 105 of FIG. 1) relative to a threshold (e.g., a threshold 124 stored in memory 105 of FIG. 1) may be examined by, for example, the processor 104 to determine whether to transmit using a portion or the entirety of a TTI window, and may be based on an identification of the packet or data that is being transmitted. While shown separately in FIG. 1, the threshold 124 and the transmission power parameter 130 may be combined into a common parameter.

The memory 105 of FIG. 1 may include one or more values of a spreading factor parameter 128, which may be examined by the processor 104 to select a spreading factor for use. For example, for downlink channel coding and frame processing, the spreading factor may be set to a value of 128, as specified in 3GPP standards for circuit-switched voice calls utilizing a 20 ms TTI. However, in some aspects of the disclosure, a spreading factor may be set to a reduced value of 64 for circuit-switched voice calls utilizing the 20 ms TTI. By utilizing the reduced spreading factor, a bit is enabled to span a shorter duration than it otherwise would. Thus, in an aspect of the present disclosure, the reduction in spreading factor, e.g., to a spreading factor of 64, may be used to obtain a transmission that consumes a portion of a TTI window as described above in connection with FIG. 7.

Puncturing techniques may be employed in connection with the use of a portion of a voice or data frame for transmission as described above with respect to FIG. 7. Puncturing entails the elimination of one or more bits, such as bits that might otherwise have been included for quality (e.g., redundancy or reliability) purposes. Referring to FIG. 1, the memory 105 includes a puncturing parameter 132 that may be examined by the processor 104 to determine whether, and to what extent, to puncture. In some examples, a reduction in quality that might otherwise be experienced using puncturing may be compensated for by increasing transmission power. Additionally, in some examples, puncturing may be used as an alternative to reducing a spreading factor to enable the frames to be transmitted utilizing only a portion of the TTI.

The memory 105 may also include one or more rate matching attributes 134. In a UMTS network, rate matching is generally used to match a number of bits to be transmitted to the number of bits available in a single frame. This is generally achieved either by puncturing the bits of a frame, and/or by repetition of bits within a frame. Rate matching may be controlled in accordance with a suitable parameter, referred to herein as a rate matching attribute. That is, a rate matching attribute may be signaled from higher layers to calculate a rate matching value, which may correspond to an amount of puncturing to apply to a frame and/or an amount of repetition of bits to apply to a frame. Accordingly, a suitable rate matching attribute may be chosen in accordance with a desired amount of puncturing. The amount of puncturing, such as the total amount of puncturing performed by a system, may be based on a capacity of one or more channels (e.g., logical or transport channels that map to physical channels). The rate matching attributes 134 may be based on, or defined in, one or more standards or specifications (e.g., a physical layer specification) and may be expressed, illustratively, in terms of a numeric value within a predetermined range of values. One or more layers may assign a rate matching attribute 134 for each transport channel. The number of bits on a transport channel can vary between different TTIs.

An explicit signal may be used to determine an amount of puncturing to perform. The use of an explicit signal may be in addition to or as an alternative to the use of rate matching attributes (e.g., rate matching attributes 134). The use of an explicit signal may provide greater flexibility, as the use of rate matching attributes is generally geared to, or based on, the size of the largest packet that may be transmitted. The use of an explicit signal may be used to tailor or customize puncturing for packets that are smaller than the largest packet that is supported. In one example, the explicit signal may be provided as part of a transport format combination set (TFCS) configuration. That is, a UMTS network provides signaling to define a TFCS configuration, where the TFCS is a set of formats that may be used for transport channels.

Another technique that may be used to provide power savings at a UE includes frame early termination (FET). Frame early termination entails terminating a transmission or receipt of a frame prior to the actual end of the frame. For example, a receiving device may be decoding a frame while the frame is being received. Over time, while the frame continues to be received, the frame may be correctly decoded in its entirety. This may occur because of redundancy in the frame, especially when the frame includes a high degree of encoding and forward error correction. At the time that the frame is decoded, the receiving device may be enabled to shut off its receiver. Furthermore, the receiving device may be enabled to transmit feedback, such as an acknowledgment message, to the transmitting device. Accordingly, the transmitting device may be enabled to terminate transmission of the frame prior to its complete transmission. This frame early termination scheme can reduce the power consumption at both the transmitting and receiving device, as well as reduce over-the-air resources utilized by the transmission of the frame. Referring to FIG. 1, the memory 105 is shown as including a frame early termination attribute 136. The frame early termination attribute 136 may indicate whether frame early termination is enabled or disabled. In some aspects of the disclosure, frame early termination may be combined with early decoding. In conjunction with early decoding, a receiver (e.g., receiver 535, 554 of FIG. 5) of a frame may detect that it has acquired the data of the frame prior to the end of the frame. The receiver may receive the data of the frame prior to the end of the frame as a result of redundancy present in the data. If the receiver obtains any needed data prior to the end of the frame, the receiver can power-down or turn-off to enable power savings. The receiver can also transmit an acknowledgement to the transmitter (e.g., transmitter 556, 532 of FIG. 5) of the frame. The transmitter, upon receipt of the acknowledgment, may stop transmitting the frame to conserve resources and may power-down to enable power savings.

Early decoding may be facilitated by the use of a common integrity check (e.g., a cyclic redundancy check (CRC)) with respect to multiple classes of bits, which may be denoted as class A, class B, and class C as described above. That is, in an AMR codec, an integrity check may be applied or determined only for a single class (e.g., class A). In this way, the information that is most sensitive to errors (e.g., class A bits) may be better preserved. Where early decoding is utilized, and in accordance with certain aspects disclosed herein, if the early decoding performed on the first class indicates that the decoding is successful (e.g., the CRC passes), it may be assumed that the second and third classes (e.g., class B and class C) are also acceptable in terms of their error rates. However, the second and third classes may in fact suffer from a degradation in quality even though the first class was acceptable. Accordingly, some aspects of the disclosure are directed to application of a common integrity check for all of the class A, class B, and class C bits, thereby improving the reliability of early decoding in terms of obtaining an error free transmission of the class A, class B, and class C bits.

To provide for the common integrity check for the several classes of bits, a joint encoding of class A, class B, and class C bits may be provided. Here, jointly encoding the several classes of bits may refer to the application of a single, suitable encoding algorithm to all of the classes of bits together. As described above, because class A bits are more sensitive to errors, they may be more robustly encoded than class B and C bits. By jointly encoding the several classes, there may be some impact to the total throughput, since, to ensure the integrity of class A bits, the less important class B and C bits would be robustly encoded, increasing redundancy. However, on the other hand, by jointly encoding the bits, a successful decoding of the class A bits, potentially based on one or more error checking algorithms or values (e.g., a checksum value, a CRC value, etc.), may enable frame early termination with respect to the class B and C bits without increasing a bit error rate (BER) of the class B and C bits that might otherwise occur if the class A, B, and C bits were not jointly encoded.

Multi-SIM User Equipment

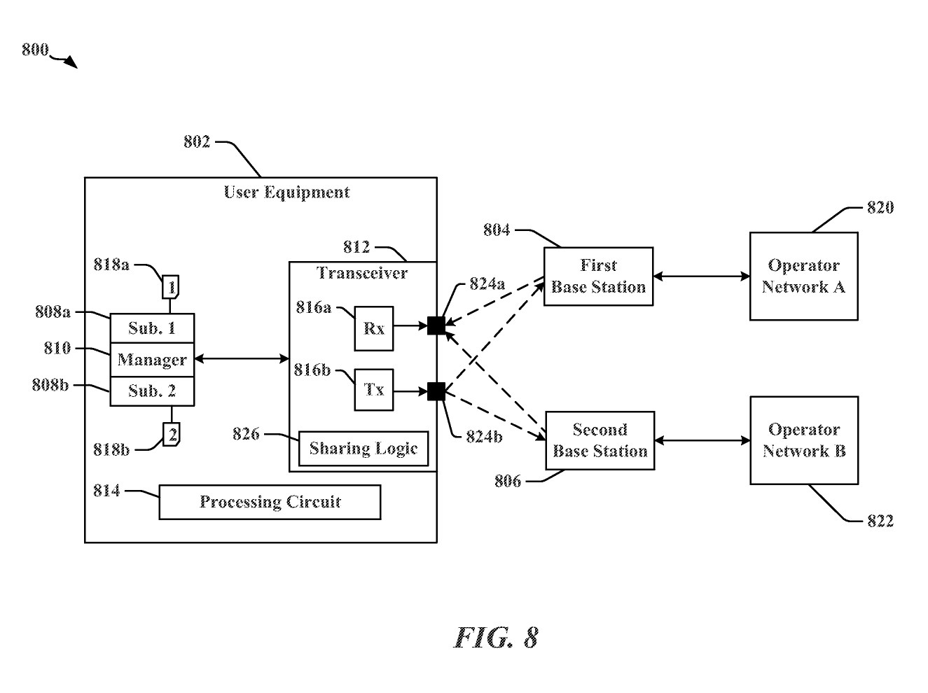

FIG. 8 is a simplified block diagram 800 illustrating a multi-SIM UE 802. The UE 802 may support a variety of operational modes when multiple SIMs 818a, 818b are installed in the UE 802. For example, in dual SIM dual stand-by (DSDS) mode, the UE 802 may initially be in standby mode for two different subscriptions. After establishing a call through one network 820 or 822, the UE 802 may cause the connection between the UE 802 and the other network 822 or 820 to enter an inactive state. The UE 802 may be equipped with a transceiver 812 that has fewer available receive (Rx) chains 816a and/or transmit (Tx) chains 816b than the number of desired active connections. In one example, the UE 802 may communicate wirelessly through one Rx chain 816a and one Tx chain 816b and associated RF interfaces 824a, 824b, which may include RF amplifiers, antennas and other RF circuitry and components. In another example, the UE 802 may have idled one or more other transceivers or one or more Rx chains 816a and/or Tx chains 816b of the transceiver 812 in order to conserve power. The UE 802 may have multiple transceivers 812 and/or RF interfaces 824a, 824b, with a corresponding plurality of available Rx chains 816a and associated RF.

The UE 802 may be configured to receive services provided by one or more core networks 820, 822. In one example, the UE 802 may obtain services from a first network 820 through a first access point 804 and may obtain services from a second network 822 through a second access point 806. The UE 802 may obtain services from a single core network 820 or 822 on behalf of two different subscriptions 808a and 808b. Each core network 820 and 822 may provide voice services, data services or some combination of voice and data services through one or more RANs operated by the same or different network operators.

The UE 802 may be adapted or configured to support two subscriptions 808a and 808b, where the subscriptions are identified or otherwise correspond to SIMs 818a, 818b installed in the UE 802. A subscription manager 810 may be provided to manage the subscriptions 808a, 808b associated with the SIMs 818a and 818b. The subscription manager 810 may be implemented in a combination of hardware circuitry and software/firmware modules or other logic elements, and the operation of the subscription manager 810 may be controlled by the processing circuit 814.

In one example, the subscription manager may be adapted to control or configure access to a shared Rx chain 816a, a shared Tx chain 816b, and/or another RF component or interface 824a, 824b, such as an antenna. In another example, the subscription manager may cooperate or otherwise interact with the processing circuit and/or sharing logic 826 to control access to a shared Rx chain 816a, a shared Tx chain 816b, and/or other RF interface 824a, 824b. The sharing logic 826 may include switches, timers, gates, state machines and other logic. The sharing logic may respond to control signals provided by the subscription manager 810 and/or processing circuit 814 to control access to the shared Rx chain 816a, shared Tx chain 816b, and/or other RF interface 824a, 824b.

The sharing logic 826 may operate on a time-sharing basis. For example, the sharing logic 826 may switch between subscriptions 818a and 818b in accordance with a timeshare schedule. The sharing logic 826 may be configured or operated to drop one or more frames, slots or data packets related to a first call when the second call is scheduled to have access to the transmit chain 816b. The sharing logic 826 may be configured or operated in a manner that causes the UE 802 to skip one or more frames, slots or packets related to a first call when the second call is scheduled to have access to the Rx chain 816a.

In operation the Rx chain 816a may be tuned from a first frequency associated with a first subscription 808a or 808b, and tuned to a second frequency associated with a second subscription 808b or 808a. An application may perceive reassignment of the Rx chain 816a between subscriptions and a resultant loss of one or more frames, slots or packets as a gap in reception of the first subscription 808a or 808b and/or the second subscription 808b or 808a. Such gaps may be referred to as tune-away (TA) gaps.

The sharing logic 826 may be provided to coordinate downlink activities, and to direct control information and traffic to the appropriate subscription 808a or 808b. The sharing logic 826 may be a component of a modem, transceiver 910, or another component, module, circuit or device within a UE 802. The sharing logic 826 may be provided between a modem and an RF card, within the RF card, or elsewhere within the UE 802. The sharing logic 826 may provide timeshared access to the Rx chain 816a, under the control and management of the processing circuit 814. In one example, the sharing logic 826 may act as a switch. The sharing logic 826 may include one or more modules of the processing circuit 814, and/or the transceiver 812, where the one or more modules control and configure a logical or physical data path through the UE 802 and/or through the transceiver 812.

The SIMs 818a and 818b can be used to identify and authenticate subscribed users of the various services offered by network operators. In one example, each SIM card 818a, 818b may store an international mobile subscriber identity (IMSI) and related keys that can uniquely identify and authenticate a subscribed user of the UE 802. Each SIM card 818a, 818b may enable access to subscribed services available to the user through the networks 820 and/or 822. Each subscription 808a or 808b may be associated with a telephone number or another network identifier, and the two subscriptions 808a and 808b typically include different telephone numbers or identifiers. In one example, the UE 802 may be a mobile telephone device equipped with two or more SIMs 818a, 818b that enable the establishment of traffic calls on one or more voice and/or data networks 820, 822. The UE 802 may be adapted or configured to maintain two or more concurrently active calls according to a configured or selected mode of operation.

The UE 802 may support a variety of operational modes when multiple SIMs 818a, 818b are installed in the UE 802. For example, in dual SIM dual stand-by (DSDS) mode, the UE 802 may initially be in standby mode for two different subscriptions. After establishing a call through a network 820, 822, the UE 802 may cause a different connection between the UE 802 and the same or a different network 820, 822 to enter a standby and/or inactive state.

In dual SIM dual active (DSDA) mode of operation, the UE 850 may be concurrently connected to one or more subscribed networks 820 and 822. A DSDA-enabled UE 802 may be capable of switching between two simultaneously active calls and/or connecting two active calls at the UE 802. In one example of DSDA mode operation, the UE 802 may establish a first active call on a first subscribed network 820, while remaining idle on a second subscribed network 822. While a call is active on a first subscribed network 820 or 822, a DSDA-enabled UE 802 may receive a second call through a second subscribed network 822 and/or 820. If calls are simultaneously active on the first and second subscribed networks 820 and 822, a user may switch between the two calls as desired, and/or may connect the two calls at the UE 802. When more than two SIMs 818a, 818b are installed in the UE 802, other modes of operation may be defined, including triple SIM dual active (TSDA) mode, quad SIM dual active (QSDA) mode, for example.

A DSDA-enabled UE 802 may include two or more RF transceivers 812. Each RF transceiver 812 may be operated independently and used for establishing and maintaining an active connection with a base station 804, 806 on behalf of subscriptions for a corresponding number of installed SIMs 818a, 818b. The RF transceivers 812 may be embodied in one or more RF modems and each transceiver 812 includes both a Tx chain 816b and an Rx chain 816a. An RF modem may assign an Rx chain 816a and a Tx chain 816b for each RF transceiver 812. Tx chains 816b may include modulators, encoders, power amplifiers and other devices and circuits. Rx chains 816a may include amplifiers, demodulators, decoders and other devices and circuits. Certain devices and circuits may be sharable between Rx chains 816a. In the example depicted in FIG. 8, the UE 802 has a single RF transceiver 812 with a dedicated Rx chain 816a and Tx chain 816b that are configured to support concurrent connections to the same or different base stations 804, 806 corresponding to networks 820 and 822, respectively. The Rx chain 816a and/or Tx chain 816b may share a single antenna. An RF modem may additionally include one or more processors, non-transitory storage and logic configured to process, transmit and receive signals, and to encode and decode data transmitted and received by the UE 802.

In some examples, the UE 802 may be adapted or configured to support one or more multi-active operational modes as disclosed herein to provide network access for multiple subscriptions 808a, 808b when the UE 802 has fewer RF transceivers 812 or fewer Rx chains 816a (and/or Tx chains 816b) than the available or desired number of connections. In DSDS and/or DSDA modes of operation, receiver blanking can occur with respect to one or more Rx chains 816a. Signaling transmitted by a network 820, 822 for a “blanked” subscription 808a, 808b may be lost during receiver blanking. In some instances portions of a frame and/or portions of a slot may be lost during receiver blanking.

In the example of CDMA, a base station 804, 806 may transmit frames related to various voice and data services on a physical channel such as a dedicated physical data channel (DPDCH). Frames may be associated with a fixed or variable transmission rate. The transmitter may provide certain parameters and other information that the receiver may use to decode a frame, when frames are transmitted at a variable rate, and/or each frame may have a different data rate. In one example, the transmitter may provide the spreading rate of each data frame, which may be determined by the data rate corresponding to the frame. Data transmission rate may be inversely proportional to the spreading rate used to encode the frame for transmission.

AMR Codecs with Early Decode in Single SIM and Multi-SIM Contexts

AMR full-rate codecs may have different degrees of redundancy due to channel coding. Certain codecs may not include any class II bits and a partial decode may be performed when channel conditions are sufficiently good. In a single SIM context partial decode can provide improved throughput and/or current savings. In a multi-SIM DSDA context, early or partial decode of DL on a first subscription can provide improvement in UL statistics such as throughput and/or signaling in the second subscription.

In a GSM example, different codecs may be assigned for a voice call. AMR codecs may include different codecs for the same category of use, where each codec has different characteristics. Certain codecs may provide more channel protection than other codecs, and a selection of codec may be based on location of the UE and/or channel quality. In one example, a codec that has better channel quality with lower channel protection may be selected when good channel conditions are available to the UE. In another example, the UE may be allocated a codec with better channel protection and lesser channel quality as channel conditions deteriorate.

Certain redundancies related to AMR codecs may be exploited to support and/or implement partial decode. For example, certain codecs may transmit extra bits to protect the transmitted source bits. Typically, a speech codec is spread over 8 bursts in GSM. In some instances, channel conditions can be gauged and a partial decode of the block may be attempted using fewer than 8 bursts. For example, a partial decode may involve the use of 4 or 6 bursts rather than all 8 bursts.

Foregoing reception of some of the bursts during partial decode provides certain advantages in different operational configurations of the UE. In the case of a single SIM configuration, current savings can be accrued by foregoing reception of the bursts. The RF circuitry is turned on to receive bursts, and may be at least partially powered down when not receiving. Thus, partial decode can provide power savings.

In the case of a multi-SIM UE, foregoing reception of certain bursts related to a first subscription may provide improved performance related to a second subscription. In one example, a UE having two active SIMs may support a voice call utilizing the AMR codec for a first subscription, while performing a data transfer for a second subscription. In this example, there may be a time overlap between activities on the respective subscriptions where, for example, the voice subscription may be receiving information at the same time as the data subscription is transmitting information. Data transmissions for the second subscription may be interrupted or suspended while the first subscription is receiving information in order to prevent transmission energy from leaking into the receive path. The information received for the first subscription may be related to a GSM voice call, which is generally assigned higher priority than data exchanges. Leakage of transmission energy may cause a de-sense on the voice subscription and cause information to be lost. Throughput on the data subscription can suffer when data transmissions for the second subscription are suspended.

In an aspect of the present disclosure, the UE may gauge the channel conditions and may determine whether the channel condition is good enough to support partial decode. Accordingly, the UE may not schedule some of the bursts. In those bursts, because they are not signaled, the other subscription does not have to suspend its transmission. Thus, the use of partial decode on the first subscription may improve throughput for the second subscription in a multi-SIM context.

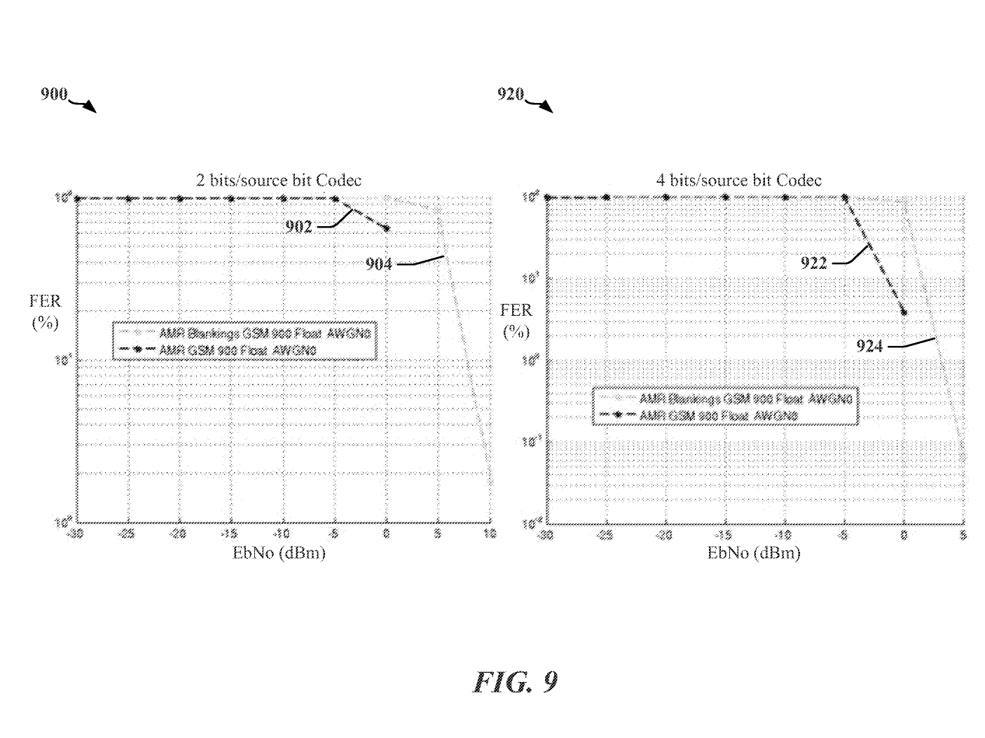

In some instances, blind partial decode may be attempted, where the UE may decode a block from a portion of the bursts transmitted on the channel without determining current channel conditions. In one example, a UE with AMR codecs may be configured to decode 4 of the transmitted 8 bursts. FIGS. 9-12 illustrate the impact of channel quality on loss observed when blind AMR partial decode (AMR-PD) is employed. FIG. 9 includes charts 900 and 920 that relate to a half-rate protected codec and a greater protected codec in a statically located UE. The half-rate protected codec may provide 2 bits for each source bit while the greater protected codec may provide 4 bits per source bit. In each chart 900, 920, a first curve 902, 922 corresponds to decoding that uses full 8-burst decoding, while a second curve 904, 924 corresponds to decoding that uses partial decode. Some losses are apparent using AMR-PD 904, 924.

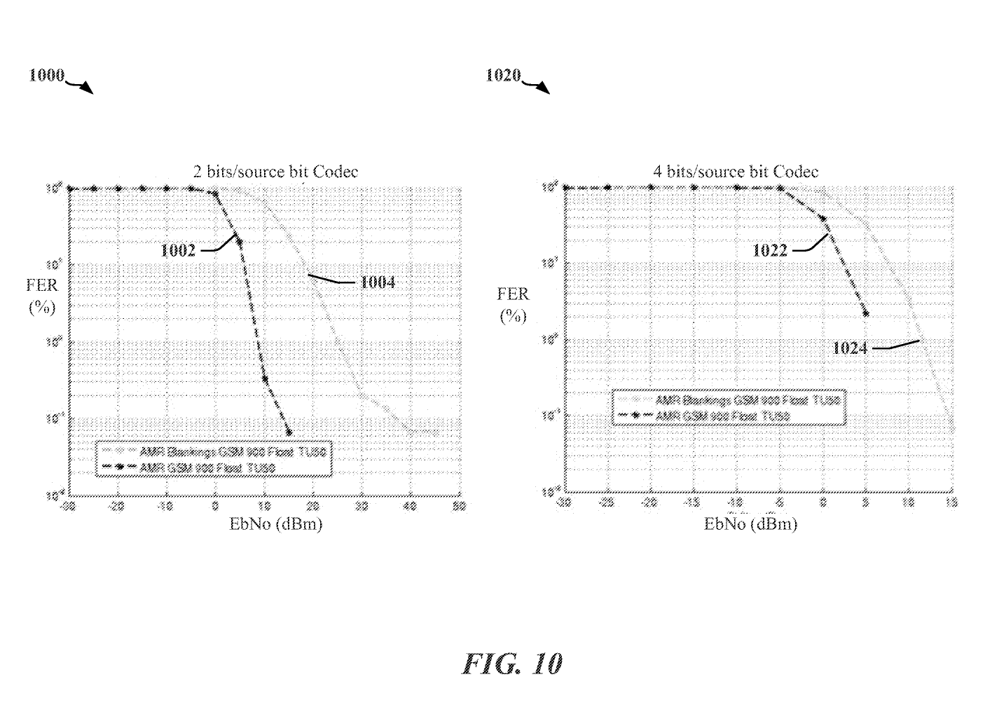

FIG. 10 includes charts 1000 and 1020 that relate to a half-rate protected codec and a greater protected codec in a moving UE. The half-rate protected codec may provide 2 bits for each source bit while the greater protected codec may provide 4 bits per source bit. In each chart 1000, 1020, a first curve 1002, 1022 corresponds to decoding that uses full 8-burst decoding, while a second curve 1004, 1024 corresponds to decoding that uses partial decode. Increased losses with respect to the static UE (FIG. 9) are apparent.

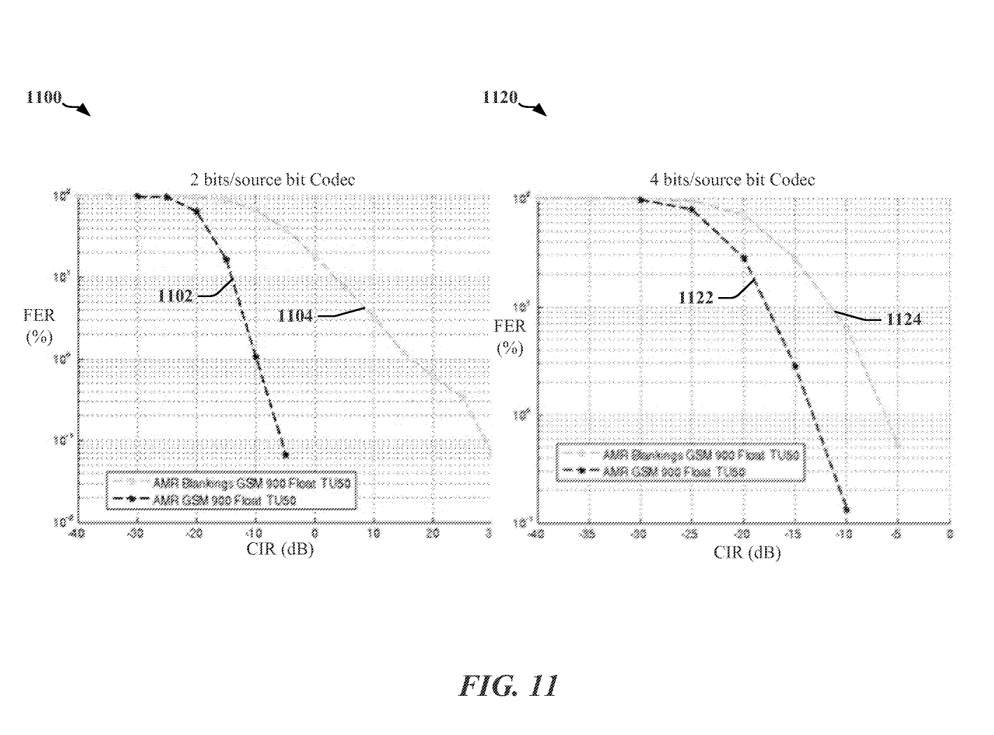

FIG. 11 includes charts 1100 and 1120 that relate to a half-rate protected codec and a greater protected codec in the presence of co-channel interference (CCI), where there is a single interferer. The half-rate protected codec may provide 2 bits for each source bit while the greater protected codec may provide 4 bits per source bit. In each chart 1100, 1120, a first curve 1102, 1122 corresponds to decoding that uses full 8-burst decoding, while a second curve 1104, 1124 corresponds to decoding that uses partial decode.

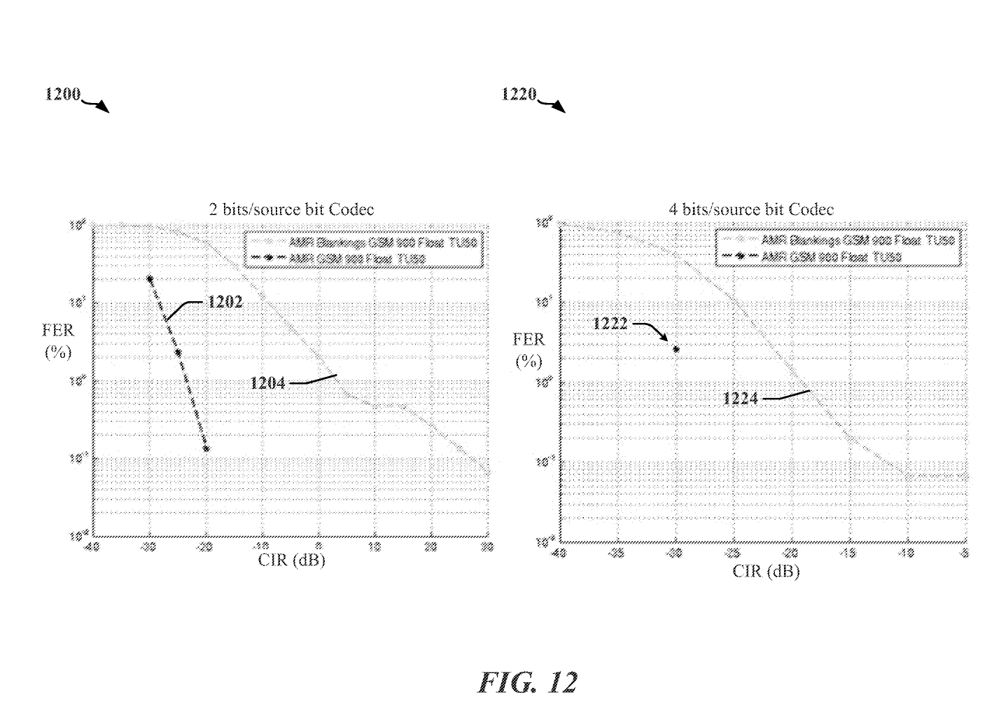

FIG. 12 includes charts 1200 and 1220 that relate to a half-rate protected codec and a greater protected codec in the presence of adjacent channel interference (ACI), where there is a single interferer. The half-rate protected codec may provide 2 bits for each source bit while the greater protected codec may provide 4 bits per source bit. In each chart 1200, 1220, a first curve 1202, 1222 corresponds to decoding that uses full 8-burst decoding, while a second curve 1204, 1224 corresponds to decoding that uses partial decode.

AMR-PD may have lesser effect on signaling messages that are embedded in traffic. In one example, the signaling messages may be transmitted for scheduling purposes, such as when the base station schedules resources for a UE that is engaged in an active voice call. In another example, the signaling messages may be transmitted in support of DTX. In another example, the signaling messages may be transmitted to inform the UE that the networking environment is changing, and to instruct the UE to act accordingly. Signaling messages may be carried in channels that employ a correlation based detection mechanism, which operates over a large amount of bits. Accordingly, channels carrying signaling messages may be quite robust, and losses during partial decode may not become evident until harsh channel conditions are encountered. In one example, a SID_UPDATE employs a ¼th rate channel coding protection.

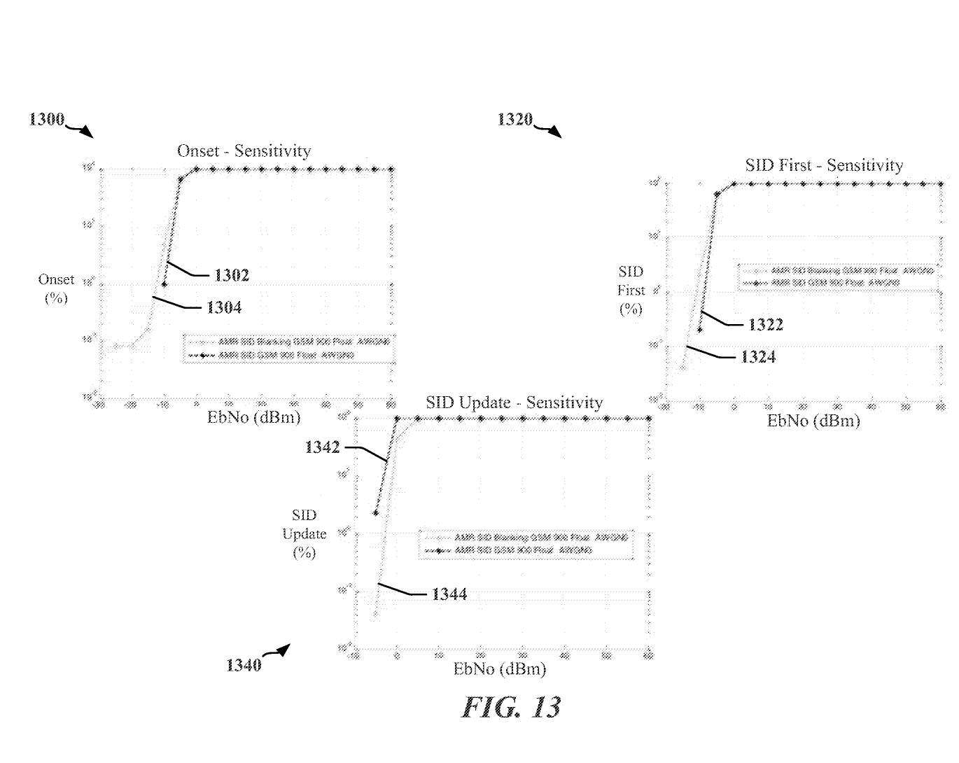

FIGS. 13-16 include examples that illustrate the robustness of signaling messages to partial decode. FIG. 13 illustrates success rate, or the 1-error rate, with curves 1302, 1322, 1342 for full 8-burst decoding and curves 1304, 1324, 1344 for partial decode under varying channel conditions. The charts 1300, 1320, 1340 may relate to different channel protection and decode methods than illustrated in FIGS. 9-12.

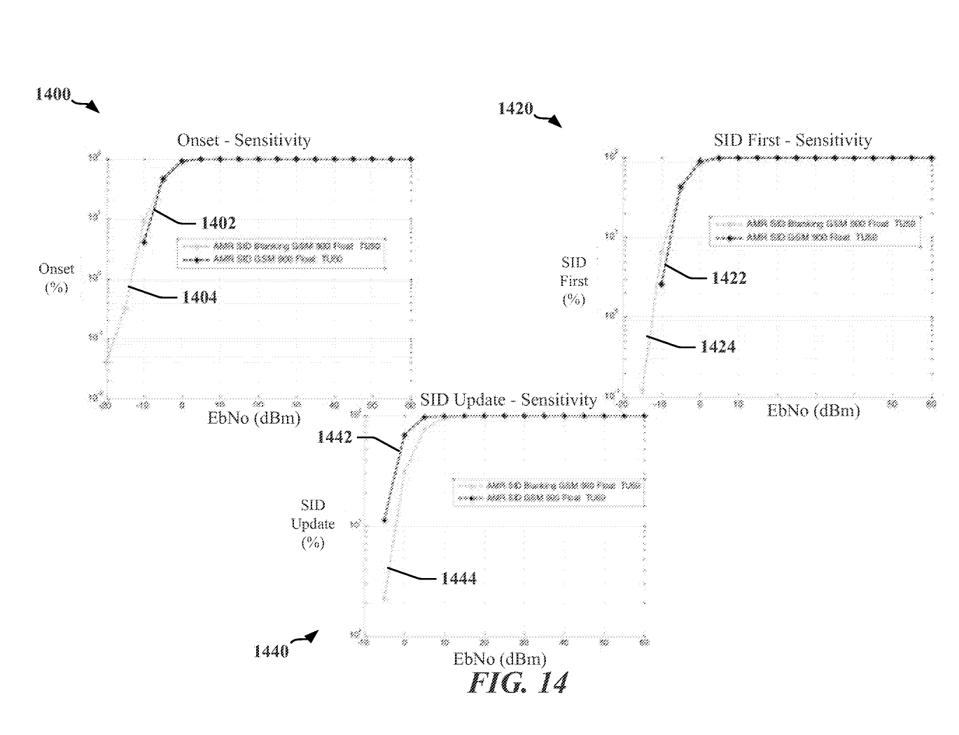

FIG. 14 illustrates success rate, or the 1-error rate, with curves 1402, 1422, 1442 for full 8-burst decoding and curves 1404, 1424, 1444 for partial decode under varying channel conditions. The charts 1400, 1420, and 1440 may relate to different channel protection and decode methods than illustrated in FIGS. 9-12.

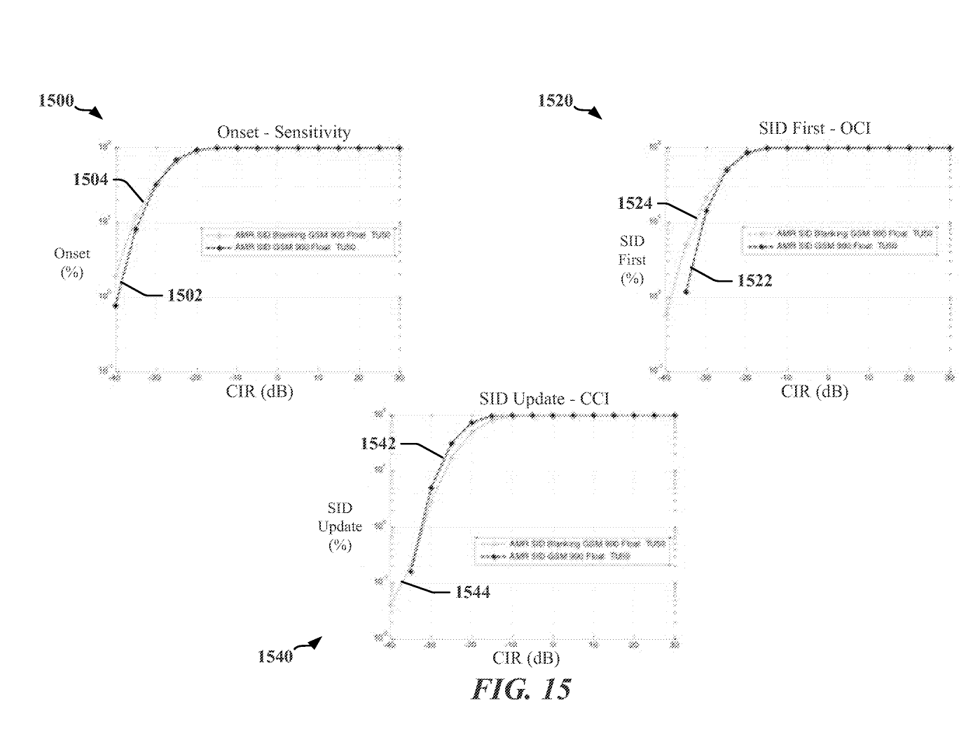

FIG. 15 illustrates success rate, or the 1-error rate, with curves 1502, 1522, 1542 for full 8-burst decoding and curves 1504, 1524, 1544 for partial decode under varying channel conditions. The charts 1500, 1520, and 1540 may relate to different channel protection and decode methods than illustrated in FIGS. 9-12.

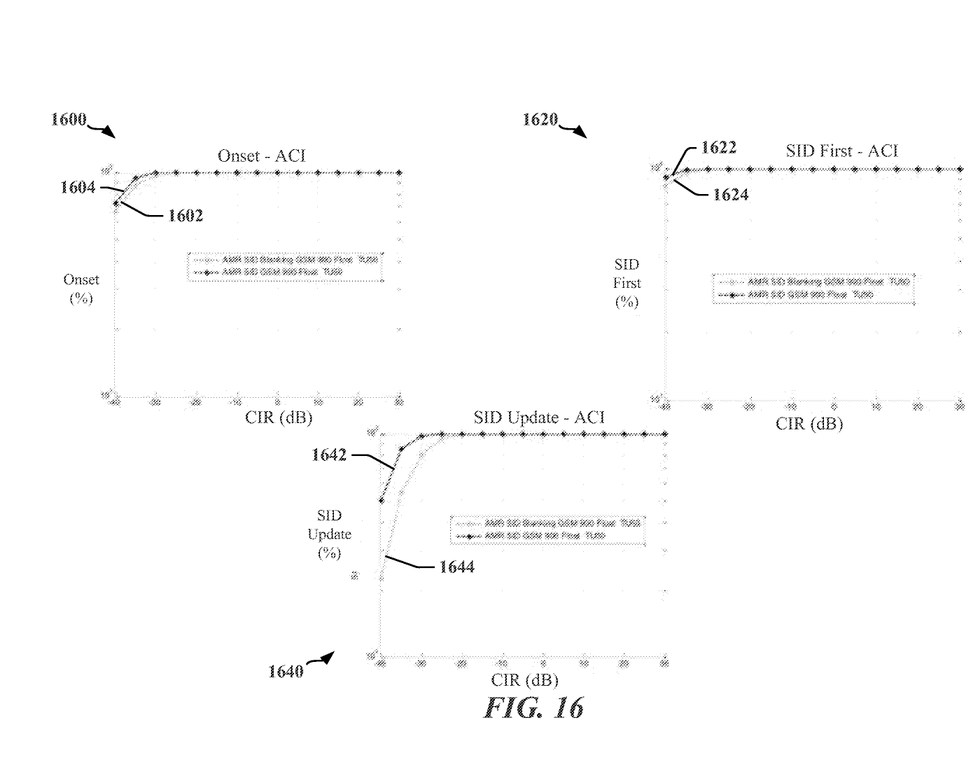

FIG. 16 illustrates success rate, or the 1-error rate, with curves 1602, 1622, 1642 for full 8-burst decoding and curves 1604, 1624, 1644 for partial decode under varying channel conditions. The charts 1600, 1620, and 1640 may relate to different channel protection and decode methods than illustrated in FIGS. 9-12.

As illustrated in FIGS. 13-16, performance obtained for partial decode is similar to the performance obtained with full decode, provided the conditions are of sufficient quality. Under certain conditions, some losses may occur and such losses may be unacceptable for signaling messages that are embedded in traffic.

Certain aspects disclosed herein enable the use of AMR-PD with voice codecs when channel conditions are unpredictable and/or changing by implementing partial decode intelligently. In one example, an activation mechanism for AMR-PD may be implemented that accounts for and/or responds to the operating conditions that a UE is experiencing. According to certain aspects, an intelligent implementation of AMR-PD adopts a multi-layered approach. In a first layer, a top-level scheduler may be implemented in protocol level software (i.e., a protocol scheduler (PS)), while in a second layer algorithms and other software may be provided in firmware to configure and/or adapt the operation of one or more equalizers.

The protocol scheduler may be adapted to respond to a snapshot of channel conditions. The UE may be configured to periodically gauge the channel conditions and to determine the quality of the channel conditions for a preceding period of time. In one example, the UE may be configured to assess channel conditions every 480 ms during a GSM voice call when the UE is already assessing channel conditions in order to provide a report to the network. The UE may be configured to provide reports through a Slow Associated Control Channel (SACCH), for example. Certain metrics reported to the network may be employed by the protocol scheduler to determine at a high level if AMR-PD can be used. Algorithms provided in the firmware layer may be activated based on the high-level determination. These firmware algorithms may analyze channel conditions in more detail to determine if AMR-PD should be activated. For example, the signal-to-noise ratio (SNR) for a number N of preceding received bursts may be considered, where 2<=N<4. The firmware algorithms may analyze channel conditions to ensure that AMR-PD is activated and/or performed only when successful CRC checks are likely or expected. In some instances, the intelligent implementation of AMR-PD may be adapted for coexistence and/or compatibility with DTX detection features. Accordingly, the use of an intelligent AMR-PD implementation in relation to a first subscription may avoid compromising performance, while obtaining benefits for another subscription supported by the UE.

### Partial Decode for Interleaved Transmissions

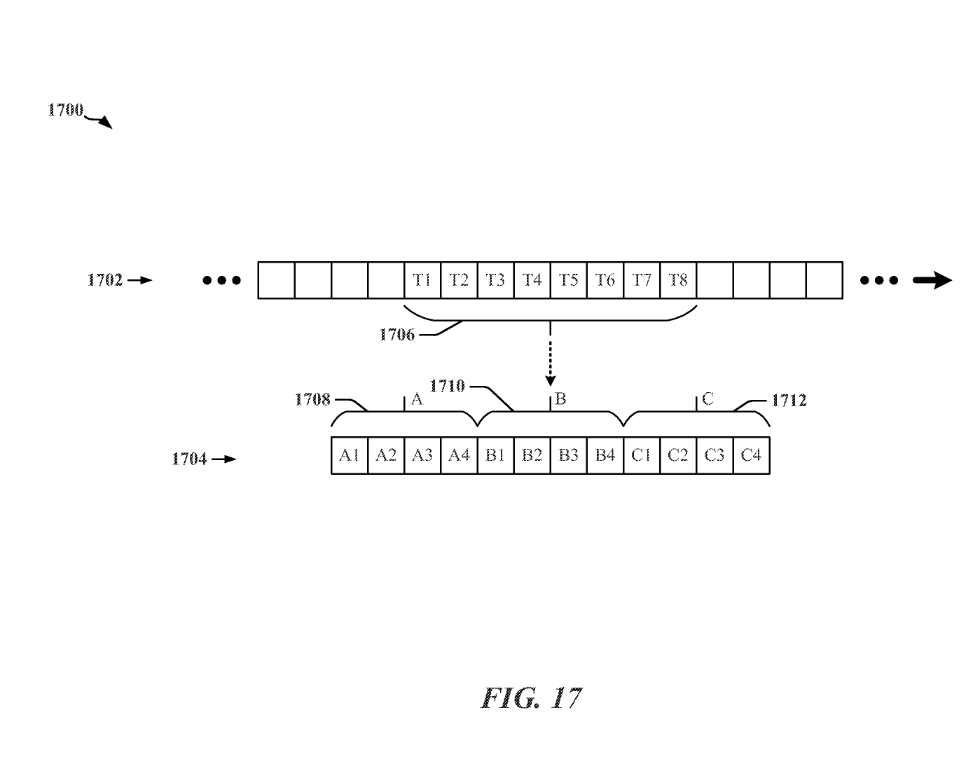

FIG. 17 is a timing diagram 1700 illustrating the decoding of blocks 1708, 1710, 1712 from a sequence of received bursts 1702. In operation, SNRs for a plurality of received bursts may be considered when determining whether AMR-PD should be enabled. In GSM, each block 1708, 1710, 1712 is spread over 8 bursts due to interleaving, such that each block 1708, 1710, 1712 is mixed with preceding and succeeding blocks 1708, 1710, 1712. For example, a block B 1710 may be interleaved over 8 bursts 1706 that are mixed with a block A 1708 and a block C 1712. In the example, when the 8 bursts 1706 are decoded to obtain the B block 1710, 4 bursts that include the C block 1712 have also been received. The next four bursts complete reception of the 8 bursts associated with the C block 1712. Accordingly, after the first block 1708 has been decoded, a new block 1710, 1712 can be decoded for every 4 bursts received.

According to certain aspects, a UE that is adapted to implement intelligent implementation of AMR-PD may determine its operability during reception of groups of 4 bursts. The UE may receive a portion (X) of the 4 bursts and may determine one or more quality metrics associated with the X bursts. The UE may then determine whether or not it should receive the remaining bursts in the group. The value of X may be variable and/or may be determined adaptively based on the codec used. Different AMR codecs can have different protection characteristics, and the value of X may be different for different AMR codecs.

The protocol scheduler may be configured to monitor one or more metrics that can establish whether conditions are good enough are good enough to invoke AMR-PD. The metrics may be derived from signaling bursts or comfort noise bursts, which are periodically received during a call. Reports sent by the UE to the network every 480 ms may include a receive quality (RxQual) metric based on signaling message and/or based on SACCH whose delivery is guaranteed. These signaling messages may be used rather than relying only on speech blocks, which can be affected by DTX. DTX causes the network to cease transmission and measured SNR becomes artificially bad. RxQual is a metric that may be provided in network measurement reports as an integer value ranging between 0 and 7, where 0 is the best quality and 7 the worst. RxQual may reflect the quality of voice transmissions, and each RxQual value corresponds to an estimated number of bit errors in a number of bursts. One type of RxQual (RxQual Sub) may be used when DTX has been activated, such that certain frames of a SACCH multiframe are not transmitted, which may lead to invalid RxQual calculation. The RxQual Sub metric is calculated from mandatory frames in the SACCH that are transmitted regardless of DTX activation.

The protocol scheduler may be configured to monitor the RxQual for valid speech blocks and/or an average RxQual (RxQual Sub) to assess the quality of the channel. A speech block may be validated by the protocol layer when the speech block has passed the CRC check. The RxQual Sub metric is obtained approximately every half second (480 ms), and the “hard” RxQual metric may be built by an algorithm related to AMR-PD from the 25 speech blocks received approximately every half second. The “hard” RxQual metric may represent the minimum quality observed across the 25 speech blocks.

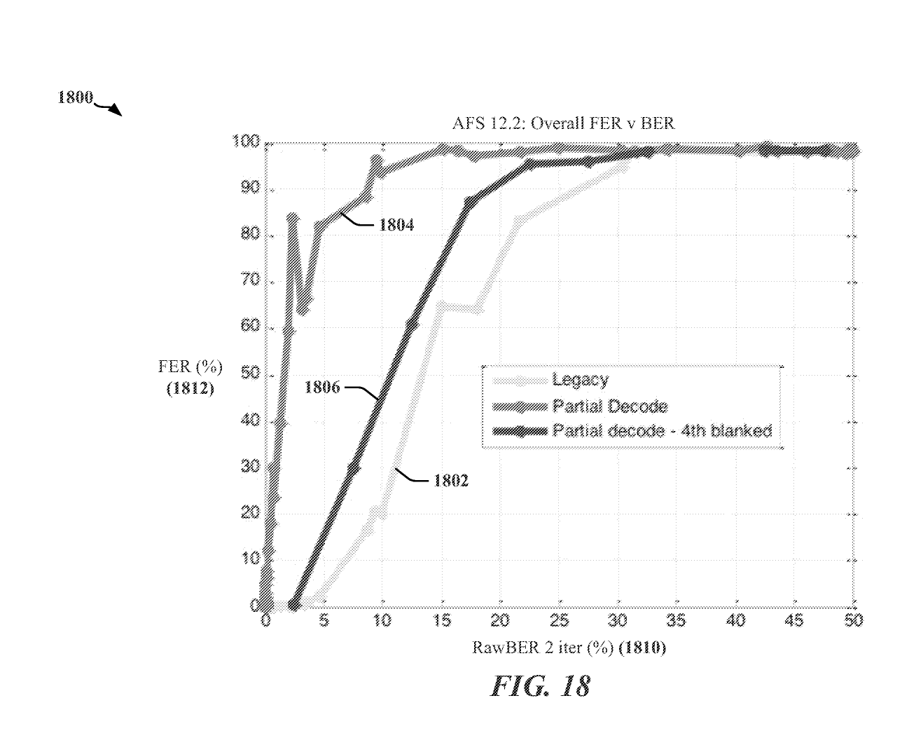

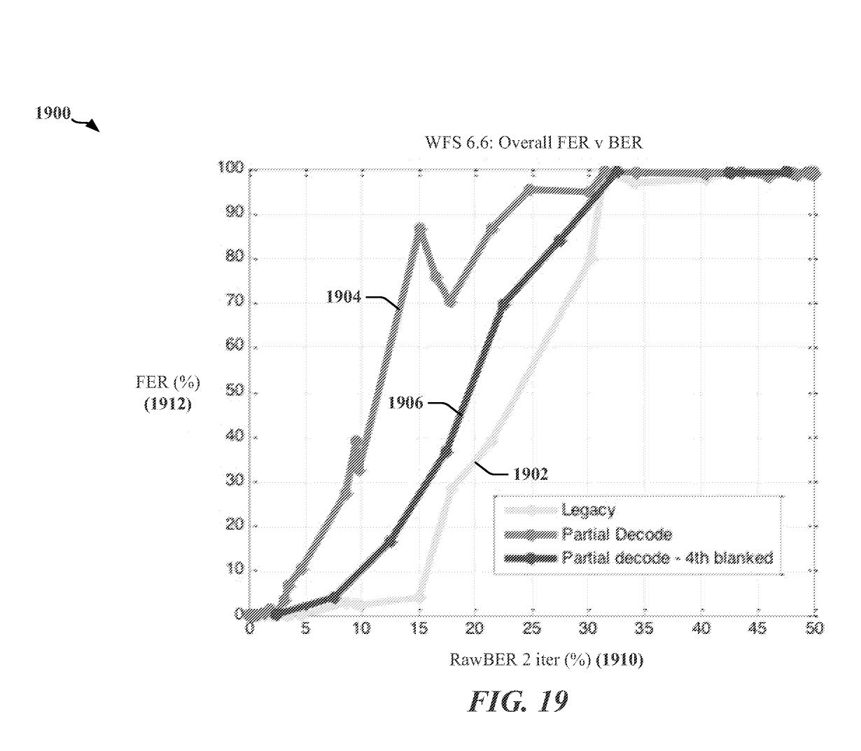

FIGS. 18 and 19 illustrate operating conditions affecting certain examples of codec. The response of the codecs to operating conditions may determine certain thresholds used to enable AMR-PD. FIG. 18 provides a chart 1800 for an Adaptive Full-Rate Speech (AFS) 12.2 codec, while FIG. 19 provides a chart 1900 for a wideband full rate speech (WFS) 6.6 codec. As illustrated in the charts 1800, 1900, the AFS 12.2 codec is unable to accomplish a desired frame error rate (FER) for any bit error rate (BER) value when AMR-PD 2/4 blanking is used, where BER is used as a measurement of error rate after decoding. When ¼th blanking is used the AFS 12.2 codec exhibits some robustness. The WFS 6.6 codec exhibits more robustness than the AFS 12.2 codec.

The x-axis 1810, 1910 of each chart 1800, 1900 corresponds to BER (burst level), and y-axis 1812, 1912 of each chart 1800, 1900 corresponds to the average FER. That is, the charts 1800, 1900 show the FER for each BER. BER may be measured based on bit errors at the equalizer output, while FER may be measured based on 8 collected bursts, after channel coding. FER is typically more robust due to channel protection, although the BER and FER may appear to be proportional for error correction processes.

The weakest codecs typically cannot tolerate BER. In the chart 1800 of FIG. 18, a first curve 1802 is related to legacy operation and shows that every block is likely to pass a CRC check until BER reaches around 3-4%. If CRC fails, no data is typically sent to a vocoder or other analysis and synthesis system that can be used to reproduce human speech. The second curve 1804 and the third curve 1806 relating to partial decode operations illustrate little or no tolerance to BER. The third curve 1806 relates to an AMR-PD scheme in which the fourth burst is blocked (¼ blanking). This curve 1806 is somewhat more robust that the second curve 1904 that relates to 2/4 blanking. From this chart 1800, it can be concluded that the threshold for BER should be 0 or close to 0 in order to ensure no loss of performance. AMR-PD offers the advantage of power-savings for voice calls. In order to avoid degradation of performance, thresholds may be selected such that FER is always zero.

Codecs with stronger protection can tolerate some BER. In the chart 1900 of FIG. 19, a first curve 1902 is related to legacy operation, the second curve 1904 relates to a 2/4 blanking AMR-PD, and the third curve 1906 relates to a ¼ blanking AMR-PD. As shown by each of these curves, the codec is less responsive to increasing BER, even when 50% blanking occurs.

FIGS. 18 and 19 illustrate the desirability of selecting effective RxQual Sub thresholds. RxQual Sub has a direct mapping to BER in a channel, and the network expects the UE to compute RxQual Sub such that it represents the BER as seen in the channel. Using the chart 1900 as an example, the BER may be selected on the x-axis 1910, and a value for RxQual Sub may be determined from the y-axis 1912 for each mode of operation.

Given that no BER should be observed when attempting AMR-PD, an RxQual threshold of 0 is typically selected to qualify AMR-PD activation.

### Threshold Selection for AMR-PD

In some instances, different thresholds may be selected for different codecs. In other instances, the link adaptation for AMR is quite active, and a simpler design warrants that a unified threshold be used. The unified threshold may be indicated by the weakest codec. In one example, the AFS 12.2 codec does not tolerate any non-zero BER value when operating in a 2/4 AMR-PD (50% blanking) mode, and a threshold of 0 is consequently indicated. In another example, the weakest codec (AFS 12.2 codec) may determine that a threshold value of 2% should be used when operating in a ¼ AMR-PD (25% blanking) mode. The UE may then determine an RxQual corresponding to the threshold BER selected.

### Managing AMR-PD

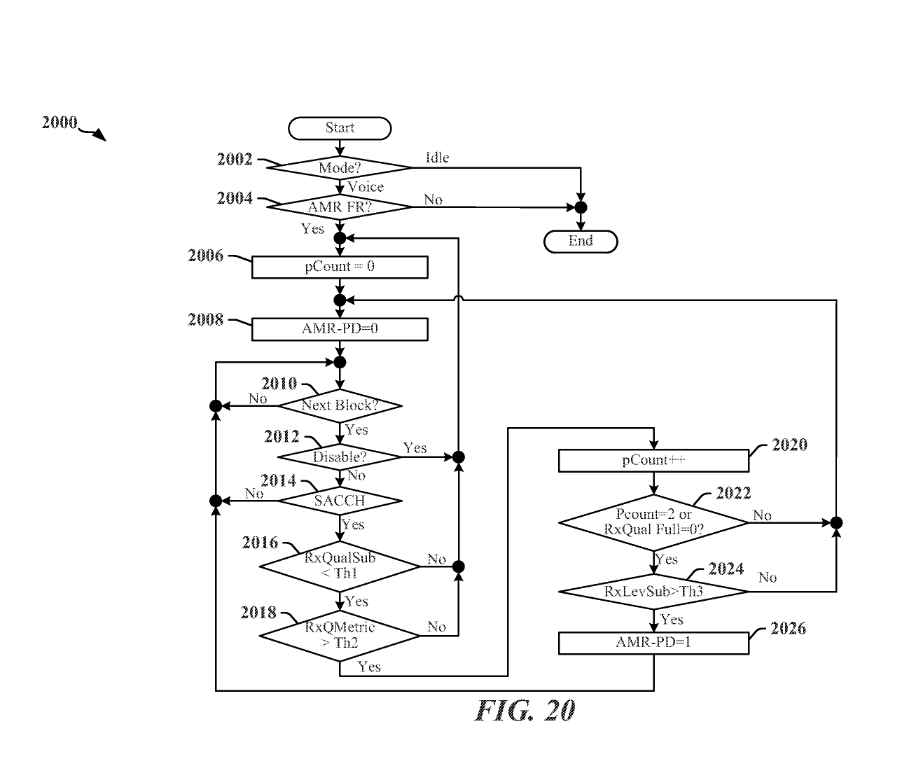

FIG. 20 is a flowchart 2000 illustrating a method for managing AMR_PD in a UE. The UE may be adapted for multi-SIM operation. At step 2002, the UE may determine a current mode of operation. AMR-PD may be employed when one subscription is engaged in an active (dedicated) vice call. If the subscription associated with the voice call is active, then the process may end. If a voice call is active, the UE may determine at step 2004 whether the protocol software has determined that the channel conditions may be suited for AMR_PD and if so, the UE proceeds to step 2006. Otherwise the process may be terminated.

At step 2006, the UE may initiate a counter (pCount) that maintains a count of the number of SACCH that have occurred. At step 2008, the UE initializes a partial decode (PD) flag to indicate that PD is not enabled. In the example, the PD flag is cleared to ‘0’ value (logic FALSE).

The UE may then wait at step 2010 for a next block to be received. When the UE determines that a block has been received, the UE proceeds from step 2010 to step 2012. At step 2012 the UE may determine at step 2004 whether the protocol software has indicated that AMR-PD should be disabled. If AMR-PD is disabled, the UE may return to step 2006 where pCount is reinitialized. The protocol software may disable AMR-PD after the occurrence of a CRC failure. Typically such disablement is temporary. If AMR-PD is not disabled by the protocol software, the process may proceed to step 2014.

If at step 2014 the UE determines that a new SACCH report is not ready, then the process loops to step 2010 where the UE waits for a next step. The SACCH report is prepared to notify the network of channel conditions on a periodic basis (e.g. every 480 ms). If an SACCH report is determined to be ready at step 2014, then the UE may analyze channel metrics at step 2016. In one example, the UE may determine if the RxQual Sub metric is less than a predefined threshold value (e.g., Th1=1). If not, the process may be restarted at step 2006. The RxQual Sub metric may represent an average of RxQual values for non-DTX speech blocks. If the RxQual Sub metric is determined to exceed the Th1 value, then the process continues at step 2018.

At step 2018, the UE may determine whether the minimum RxQual metric (RxQMetric) observed for all non-DTX speech blocks is less than a second threshold (Th2) and, if so, the process may be restarted at step 2006. In one example, the value of Th2 may be set to 32767. If RxQMetric is determined to be equal to, or to have exceeded Th2, then the process continues at step 2020, where pCount is incremented.

Next, at step 2022, the UE may determine whether pCount now has a value of 2 indicating that three SACCH periods have passed (approximately 1.5 seconds) and whether the RxQual metric has been consistently good or perfect over the SACCH period. If either condition is not met (poor quality or if three SACCH period evaluation), the process may be restarted at step 2006. Otherwise, the UE may check receiver power level (RxLevSub) at step 2024 to determine if the power level exceeds a third threshold (Th3) level. In one example, Th3 may be set to a value of ‘5.’ If the power level is deemed insufficient at step 2024, then the process may be restarted at step 2006. Otherwise, the UE may enable AMR-PD by setting the AMR-PD flag to a ‘1’ value (logic TRUE), before continuing at step 2010 where the UE waits for a next block.

In one example, AMR-PD status may be reviewed every 480 ms or so. In 480 ms, 25 speech blocks may be received. The UE considers the RxQual metric, which may correspond to BER in a speech block that has passed CRC. When the 25 voice blocks have passed CRC with a certain acceptable BER, then AMR-PD may be enabled or activated. The UE may consider average RxQual (RxQual Sub) and minimum RxQual (RxQMetric) in determining channel conditions over the 25 block transmission period.

A UE adapted for multi-SIM operation may monitor received bursts for voice traffic corresponding to a first subscription to determine when a second subscription should refrain from transmitting data. When it is established that partial decode can be performed the UE may monitor the quality of received bursts according to a layer 2 algorithm, which may be incorporated in firmware and/or performed by a processor in the UE, which may include or cooperate with an equalizer. This may be referred to as the Algorithm Performance Layer (APL).

The APL may communicate with a multi-SIM resource manager in the UE. The multi-SIM resource manager may include or be referred to as a coexistence manager (CxM). The multi-SIM resource manager may handle certain aspects related to subscriptions in a multi-SIM UE, and may cause a cessation of communication related to one subscription when such communication would adversely affect the operation of another subscription. In one example, the UE may maintain a first context in which communications related to a first subscription are handled, and a second context in which communications related to a second subscription are handled. The first context may not be aware of the existence and/or operational state of the second context, and vice versa. Accordingly, a context involved in voice communications may register with the multi-SIM resource manager in order to notify that a high priority activity is in progress that may be adversely affected by transmissions of data related to the other context. When a voice call is registered with the multi-SIM resource manager, the data call may refrain from transferring data when there is a time overlap between RF activities of the subscriptions. When the context involved in a voice connection does not register with the multi-SIM resource manager, additional time may be available to the other context for conducting data exchanges.

Having determined that AMR-PD should be enabled, the APL may register the first two bursts of each speech block with the multi-SIM resource manager according to normal practice. The APL may determine whether the last two bursts of the speech block should be registered (or deregistered if already registered) based on one or more factors, including an indication received from the protocol scheduler of the first layer that AMR-PD should be performed. The APL may consider the minimum SNR of two or more bursts previously processed for a block and registered with the multi-SIM resource manager. The APL may consider any failure of block to pass a CRC check while running AMR-PD. If such CRC fail has occurred, the APL may signal the protocol scheduler of the first layer that AMR-PD should be disabled.

The number of bursts for which the SNR is examined by the APL may be determined based on the type of codec in use. For example, the AFS 12.2 may require at least 6 bursts for decoding, and the number of bursts for which SNR is examined may be set to 3. Frame errors can be recovered using two bursts, but another part of the speech block may be corrupted. The SNR may indicate that channel conditions are good enough such that a remaining burst or bursts may be blanked. That is to say, where four bursts are available to be received, the SNR for the first two bursts may be examined and the remaining two bursts need not be received if the SNR indicates good channel conditions. When bursts are not received, circuits may be turned off or idled and current consumption can be curtailed. The APL may deregister or refrain from registering the last two bursts with the multi-SIM resource manager such that another subscription may transmit or receive at the time the last two bursts are scheduled. If the SNRs indicate that the channel conditions are not sufficiently good, then partial decode may not be attempted for the corresponding block. Partial decode decisions may be taken on a block-by-block basis, typically after a predefined number of bursts have been received.

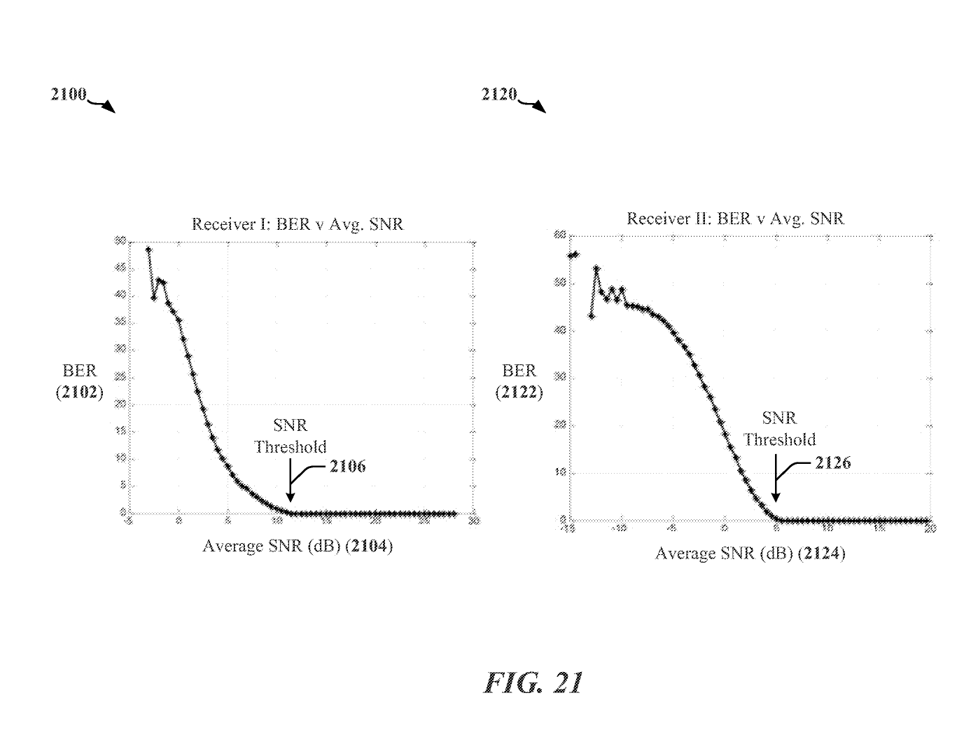

FIG. 21 includes charts 2100 and 2120 that plot BER 2102, 2104 against average SNR. The BER is expressed as the actual BER value per burst. A first chart 2100 represents BER when a first receiver is used, while the second chart 2120 represents BER in a second receiver. In the example depicted, the SNR threshold to obtain zero error bits in the first receiver may be 12 dB, while the SNR threshold to obtain zero error bits in the second system may be 6 dB. The chart 2100 represents performance of a single codec, and other charts may be plotted to allow selection of a mode of operation for a selected codec and observed SNR.

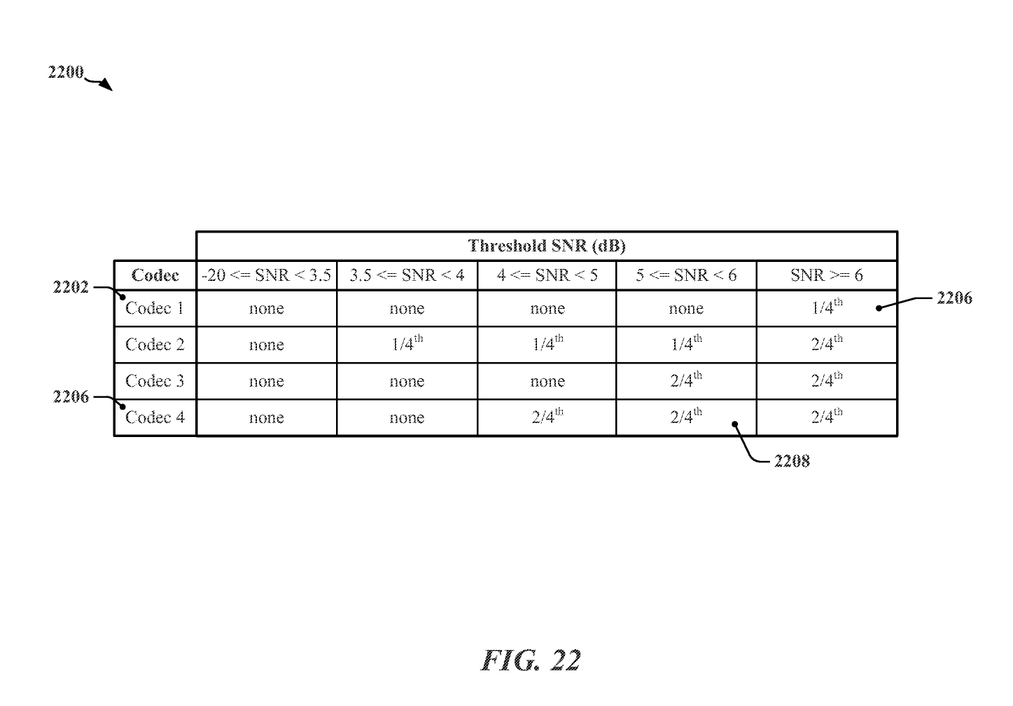

FIG. 22 illustrates an example of a table 2200 that may be maintained by a UE to configure AMR-PD. In the example depicted, the UE may be configured to support groups of 4 codecs and the table 2200 may be used to identify a mode of AMR-PD that can be used with a selected codec for an observed SNR. In one example, a ¼^{th} mode of operation 2206, in which one of four bursts is blanked, may be selected for a lowest protected codec 2202 when the SNR is above a threshold value (here SNR>=6) that indicates very good channel conditions. AMR-PD may not be usable with the lowest protected codec 2202 when SNR is less than the threshold value. In a second example, a 2/4^{th} mode of operation 2208, in which two of four bursts is blanked, may be selected for a better protected codec 2206 when the SNR lies within a predetermine range of values.

The UE may maintain multiple tables representing different groupings of modems, for example. In some instances, the UE may maintain a table that is usable when more or less than four codecs are supported by the UE. In some instances, the table 2200 may be modified or updated based on observed performance, changing network conditions, or for other reasons. The table 2200 may be customized to match thresholds and blanking rates for individual codecs, when attempting AMR-PD.

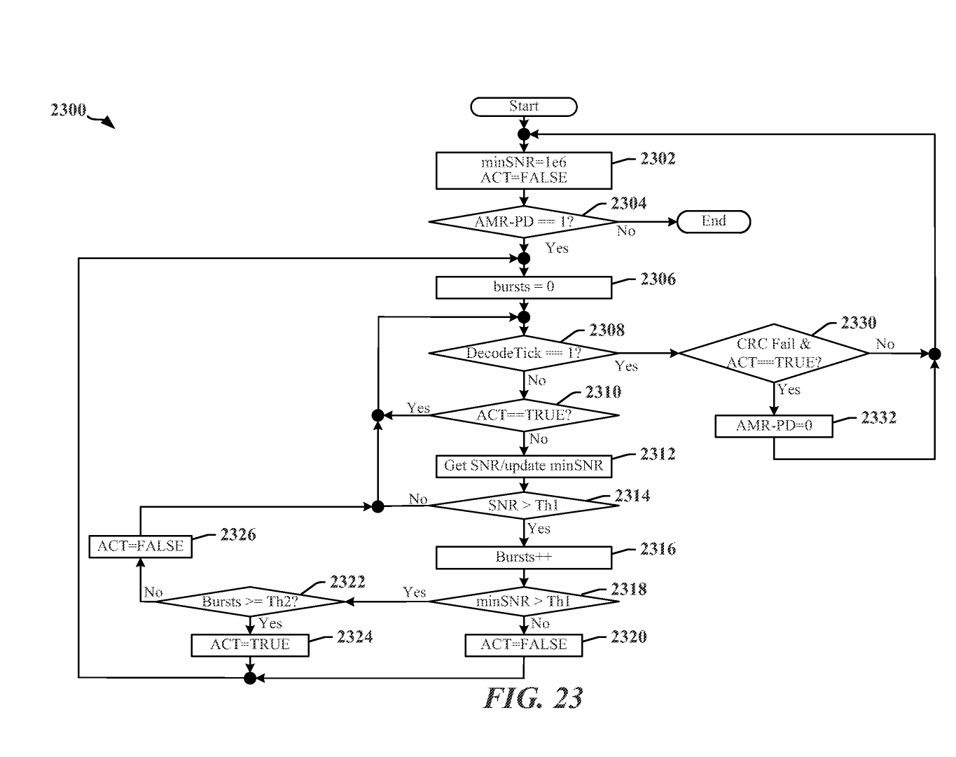

FIG. 23 is a flowchart illustrating a process that may be used to control the operation of AMR-PD as executed in lower levels of the protocol stack. In some examples, the process may be included in equalizer firmware. At block 2302, the minimum SNR value may be set and AMR-PD may be disabled by setting the ACT flag to logic FALSE (e.g., binary ‘0’). At block 2304, the AMR-PD flag may be checked to determine whether AMR-PD is enabled. In one example, the AMR-PD flag is set at step 2026 of the process illustrated in FIG. 20. If AMR-PD is determined to have been disabled, the present process ends. Otherwise, the process continues at block 2306, where a burst counter is cleared to a ‘0’ value.

At block 2308, it s determined whether a decode tick has occurred indicating that a group of 4 blocks has been completely received. If a decode tick is detected at block 2308, then the process is terminated for the current group of bursts at block 2330. At block 2330, it may be determined if a CRC failure occurred while AMR-PD was active. If so, the AMR-PD flag is cleared at block 2332, and otherwise the process is repeated for the next group of bursts at block 2302. If at block 2308, it is determined that a decode tick has not occurred, the process continues at block 2310.

At block 2310, it is determined whether AMR-PD is already active. If AMR-PD is already active, the process resumes at block 2308 (waiting for a decode tick). Otherwise, at block 2312 the current SNR is obtained and the minimum SNR value (minSNR) is updated as needed. The value of minSNR is updated to reflect the value of the current SNR if the current SNR is less than minSNR.

At block 2314, the current SNR is compared to a first threshold value (Th1). If the current SNR is not greater than Th1, the process continues at block 2308. Otherwise, the burst counter is incremented at block 2316. Next, at block 2318 minSNR is compared to the threshold value (Th1). If minSNR is not greater than Th1, AMR-PD may be deactivated by setting ACT to binary FALSE. Otherwise, the process continues at block 2322.

At block 2322, the value of the burst counter is compared to a second threshold (Th2). If the burst counter is greater or equal to Th2, then AMR-PD is enabled setting ACT to binary TRUE, permitting additional bursts to be ignored. Otherwise, AMR-PD is disabled by setting ACT to binary FALSE. When ACT is set to binary “TRUE,” the UE may not register the receiver with the multi-SIM resource manager. When ACT is set to binary “FALSE,” the receiver is registered normally with the multi-SIM resource manager.

In one example, Th1 may be set to 12 dB or 6 dB based on the current active equalizer, Th2 may be set to 2. It will be appreciated that the burst counter counts the number of bursts with good quality, during a reception of a speech block.

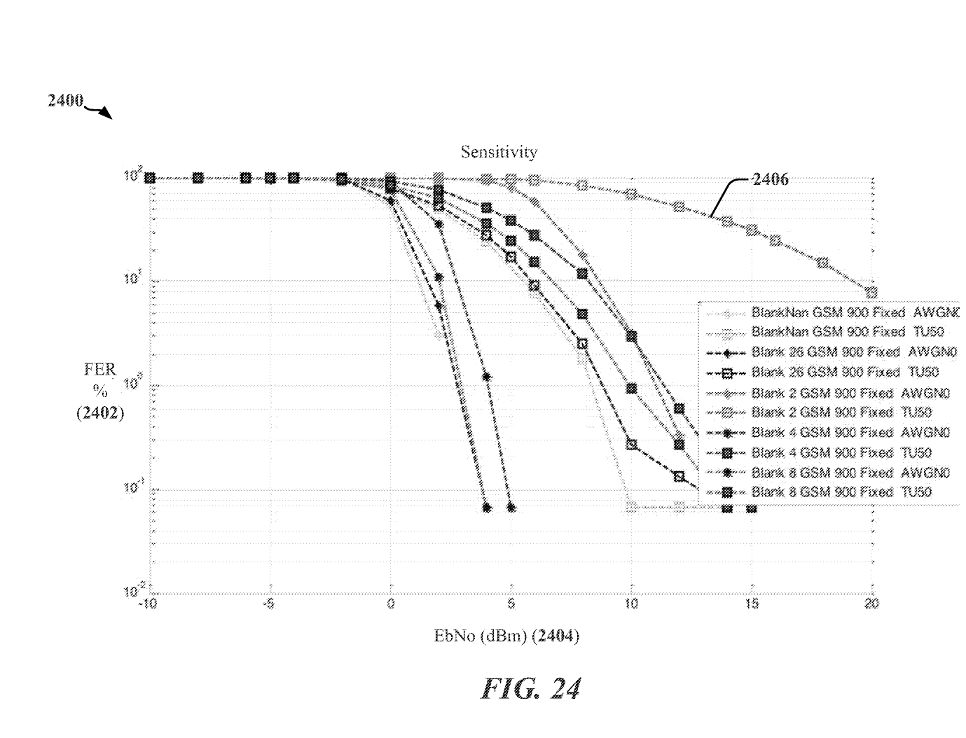

FIGS. 24-26 relate to certain characteristics of an AFS 12.2 codec. As noted herein, the AFS12.2 is an adaptive full-rate speech codec. The AFS 12.2 codec may be operated using half-rate AMR. According to certain aspects disclosed herein, the AFS 12.2 may be preferably operated using 1 burst blanking for every 4 bursts (¼^{th} mode) rather than the 2 burst blanking for every 4 bursts discussed herein, which may not be able to recover all information bits due to puncturing.

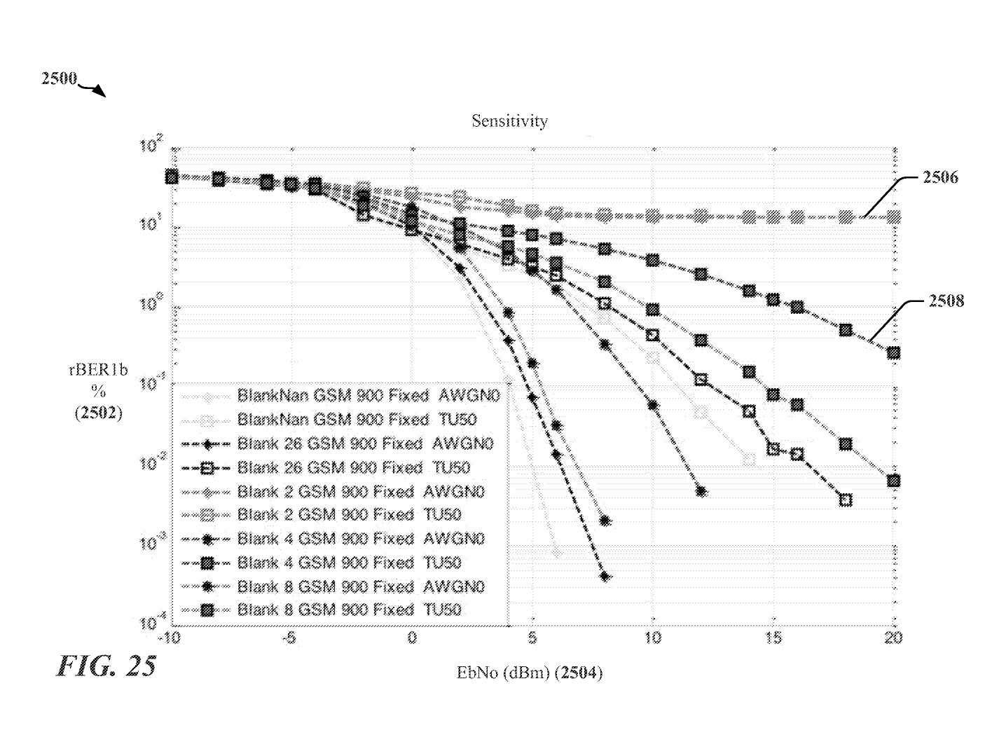

FIGS. 24 and 25 include charts 2400 and 2500 that depict AFS 12.2 codec sensitivity for different configurations. In the chart 2400, FER percentage is plotted against energy per bit to noise power spectral density ratio (Eb/NO). In the chart 2500, a residual bit error rate (rBER) statistic rBER1b is plotted against Eb/NO. rBER is a receive quality metric that may quantify the accuracy of the received data. It can be observed from the charts 2400, 2500 that the FER may drop off as channel quality improves, including for 2/4^{th} mode of operation (curve 2406), while rBER1b does not show the same reduction as channel quality improves (see curve 2506). The rBER statistic may reflect the effects of puncturing which can result in an inability to determine whether one or more information bits have been accurately decoded. In FIG. 25, rBER1b decreases when ¼^{th} mode of operation (curve 2408) is used. Accordingly, the 2/4^{th} mode of operation may be employed in an AFS 12.2 codec when channel conditions are good.

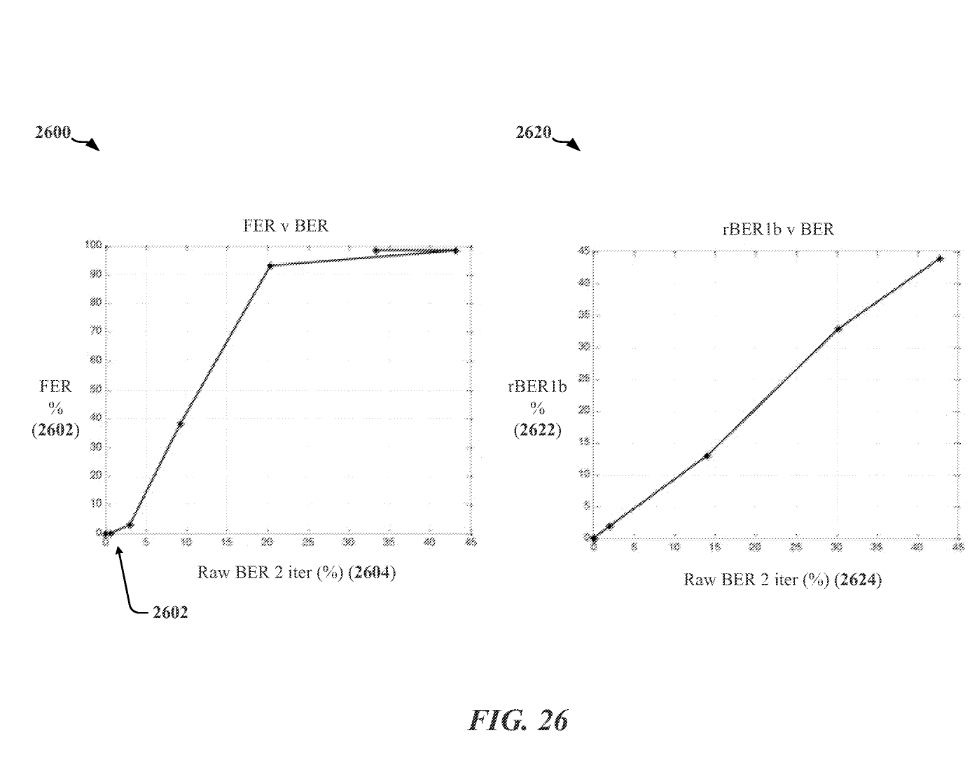

FIG. 26 includes a chart 2600 that illustrates the relationship between FER and BER in the AFS 12.2 codec, and a chart 2620 that illustrates the relationship between rBER1b and BER in the AFS 12.2 codec. As indicated generally at 2602, ¼^{th} blanking may add robustness to the performance of the AFS 12.2 codec. However, the desire or requirement for a zero rBER1 value may suggest that 0 BER should be accomplished at burst level.

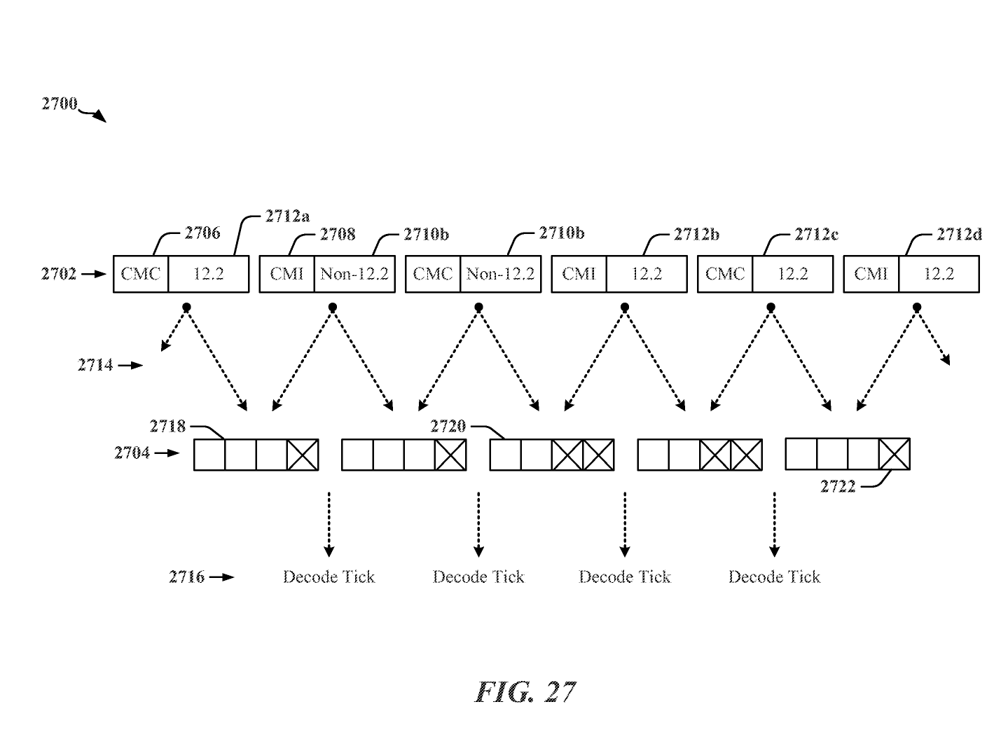

FIG. 27 is a diagram 2700 that illustrates certain operational aspects of AMR-PD. In the example, a sequence of blocks 2702 may be interleaved 2714 to produce a plurality of groups 2704 of four bursts that can be decoded at each of a plurality of “decode ticks” 2716. In the example, the codec used to encode certain blocks 2712a-2712d may be an AFS 12.2 codec, while the codec used to encode other blocks 2710a, 2710b may be a codec that is not an AFS 12.2 codec. The current codec may be defined as one of the codecs within an active codec set maintained by the UE. The codec that is used on the downlink and/or the uplink can be changed based on signaling between a base station and the UE. The codec used for a block may be indicated in an in-band control message, which may be a codec mode indication (CMI) message 2708. A codec mode command (CMC) 2706 may be transmitted to the UE to change the codec mode used on the uplink. In some instances, the UE may request a new codec on the downlink using a codec mode request (CMR) message.

In the depicted example, the selected codec is initially an AFS 12.2 codec and each group of bursts 2718 may be decoded using AMR-PD with ¼^{th} blanking. At some point a CMI 2708 may be transmitted that indicates the next block uses a non-AFS 12.2 codec, and decoding of subsequent bursts 2720 may employ AMR-PD with 2/4^{th} blanking. A blanked burst 2722 is indicated with an “X” annotation in the drawing. Regarding the multi-SIM resource manager, in this example, registration can be defaulted to a deregistration ratio of 3:1. When the CMI 2708 is received indicating the use of a non-12.2, then the registration may be switched to a ratio of 2:4. This approach has limited impact on AFS 12.2 codec operation, since at most two blocks may lose some class 1b bits when AFS 12.2 codec is in use. In some instances, the UE is required or expected obtain de-sense information for every frame where a deregistration is attempted.

According to certain aspects disclosed herein, the blanking of bursts during AMR-PD operations may be handled by a receive processor 570 (see FIG. 5). In one example, bursts may be blanked at a de-interleaver in the receive processor 570. The bursts may be blanked at the de-interleaver input based on one or more criteria. The criteria may include indications that another subscription received a TX proceed. The criteria may include a determination that SNR for the bursts was less than 10 dB.

When the number of blanked bursts (x) per decode block is known, the hard RxQual may be scaled as follows:

$${RxQual}_{scaled} = ( \frac{8}{( 8 - x )} ) \times RxQual .$$

AMR SNR may be disregarded when blanking occurs because another subscription received a TX proceed. If SNR >10 dB, but is a result of de-sense, the SNR may not be properly considered as representing the channel conditions.

AMR-PD may be disabled when a loopback mode is activated by the protocol layer (APL).

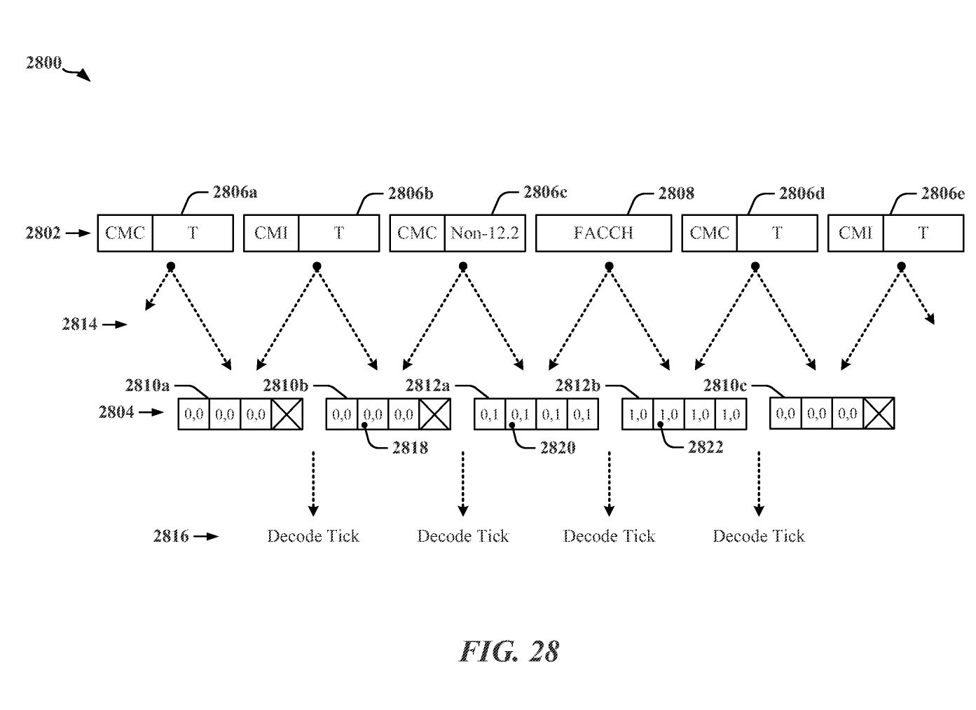

FIG. 28 is a diagram 2800 that illustrates certain operational aspects of AMR-PD related to fast associated control channel (FACCH). FACCH is a logical channel on that may be used to send urgent signaling control messages, including handoff and/or power control messages. FACCH messages replace speech data with signaling data for short periods of time. In GSM two special reserved bits are used to inform the UE whether data in the current block includes subscriber traffic or a FACCH message. In the example, subscriber traffic is present when one of the two reserved bits is set to a ‘0’ value, and subscriber traffic is present when one of the two reserved bits is set to a ‘1’ value. Interleaving 2814 results in the FACCH message being present in two of the groups of bursts 2804. Accordingly, the reserved bits indicate which block includes the FACCH message. For example, the reserved bits are set to {0, 0} when subscriber traffic is provided in both blocks 2806a, 2806b, 2806c, 2806d, and/or 2806e encoded in a group of 4 bursts 2810a, 2810b, or 2810c. The reserved bits are set to {0, 1} when subscriber traffic is provided in the first block 2806c encoded in a group of 4 bursts 2812a while an FACCH message is provided in the subsequent block 2808 encoded in the group of 4 bursts 2812a. The reserved bits are set to {1, 0} when an FACCH message is provided in the first block 2808 encoded in a group of 4 bursts 2812b while subscriber traffic is provided in the subsequent block 2806d encoded in the group of 4 bursts 2812b. The reserved bits may be referred to as “stealing flags.”

The APL may check the stealing flags of the first N bursts (N=2 or 3) in order to determine whether AMR-PD should be performed for the related block or blocks. When the bursts encode subscriber traffic and satisfy the SNR threshold for AMR-PD, The stealing flags can be trusted since BER is expected to be extremely low for such bursts. AMR-PD is typically not employed when a block is associated with a stealing flag that is set to a ‘1.’ Consequently, a “normal” mode of multi-SIM resource manager registration may be set for the remaining bursts.

### Certain Power Saving Aspects

In a UE that is adapted for multi-SIM operation, the deterioration of the deregistered bursts may depend on activity associated with another subscription supported by the UE. In one example, no de-sense may be required if the other subscription is in an idle mode. For power saving purposes, however, such decisions are made in advance, and blanking may be unconditional when a determination is made to perform AMR-PD for the remaining frames in a speech block.

The impact of such self-blanking may be compensated in the following cases:
Loopback C, where the AMR-PD algorithm is disabled by APL
PS tracking loops, including automatic frequency control (AFC), time tracking, and/or automatic gain control (AGC).
   Interface context may be saved for the last frame and used for the blanked bursts.

### Example of a Processing Circuit Configured to Perform AMR-PD

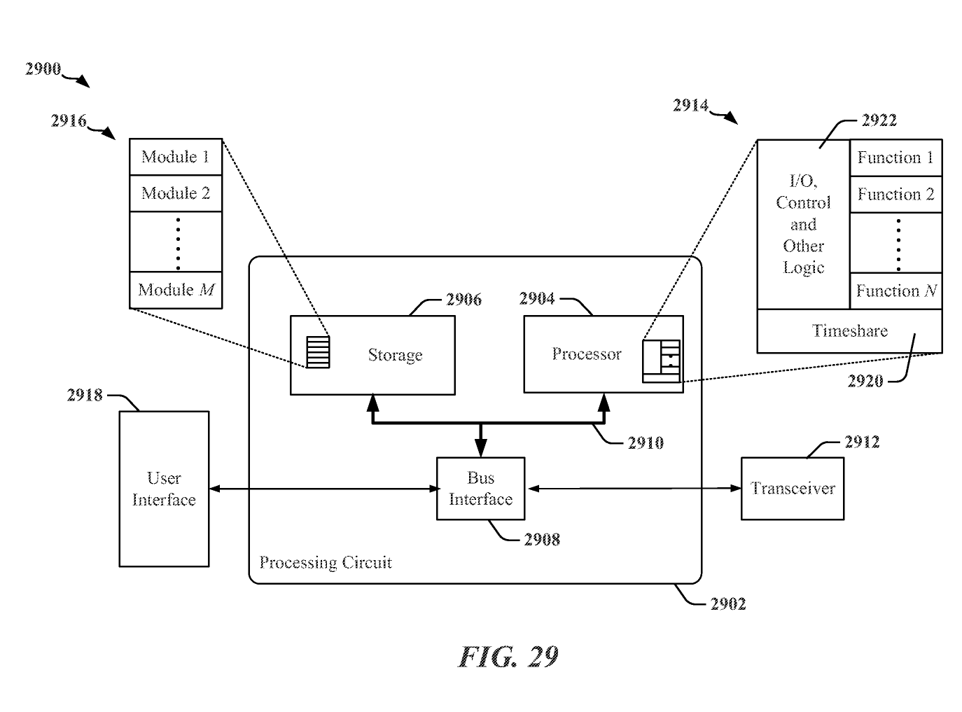

FIG. 29 is a conceptual diagram 2900 illustrating a simplified example of a hardware implementation for an apparatus employing a processing circuit 2902 that may be configured to perform one or more functions disclosed herein. In accordance with various aspects of the disclosure, an element, or any portion of an element, or any combination of elements as disclosed herein may be implemented using the processing circuit 2902. The processing circuit 2902 may include one or more processors 2904 that are controlled by some combination of hardware and software modules. Examples of processors 2904 include microprocessors, microcontrollers, digital signal processors (DSPs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 2904 may include specialized processors that perform specific functions, and that may be configured, augmented or controlled by one of the software modules 2916. The one or more processors 2904 may be configured through a combination of software modules 2916 loaded during initialization, and further configured by loading or unloading one or more software modules 2916 during operation.

In the illustrated example, the processing circuit 2902 may be implemented with a bus architecture, represented generally by the bus 2910. The bus 2910 may include any number of interconnecting buses and bridges depending on the specific application of the processing circuit 2902 and the overall design constraints. The bus 2910 links together various circuits including the one or more processors 2904, and storage 2906. Storage 2906 may include memory devices and mass storage devices, and may be referred to herein as computer-readable media and/or processor-readable media. The bus 2910 may also link various other circuits such as timing sources, timers, peripherals, voltage regulators, and power management circuits. A bus interface 2908 may provide an interface between the bus 2910 and one or more transceivers 2912. A transceiver 2912 may be provided for each networking technology supported by the processing circuit. In some instances, multiple networking technologies may share some or all of the circuitry or processing modules found in a transceiver 2912. Each transceiver 2912 provides a means for communicating with various other apparatus over a transmission medium. Depending upon the nature of the apparatus, a user interface 2918 (e.g., keypad, display, speaker, microphone, joystick) may also be provided, and may be communicatively coupled to the bus 2910 directly or through the bus interface 2908.

A processor 2904 may be responsible for managing the bus 2910 and for general processing that may include the execution of software stored in a computer-readable medium that may include the storage 2906. In this respect, the processing circuit 2902, including the processor 2904, may be used to implement any of the methods, functions and techniques disclosed herein. The storage 2906 may be used for storing data that is manipulated by the processor 2904 when executing software, and the software may be configured to implement any one of the methods disclosed herein.

One or more processors 2904 in the processing circuit 2902 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2906 or in an external computer readable medium. The external computer-readable medium and/or storage 2906 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 2906 may also include, by way of example, a carrier wave, a transmission line, and any other suitable medium for transmitting software and/or instructions that may be accessed and read by a computer. Computer-readable medium and/or the storage 2906 may reside in the processing circuit 2902, in the processor 2904, external to the processing circuit 2902, or be distributed across multiple entities including the processing circuit 2902. The computer-readable medium and/or storage 2906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2906 may maintain software maintained and/or organized in loadable code segments, modules, applications, programs, etc., which may be referred to herein as software modules 2916. Each of the software modules 2916 may include instructions and data that, when installed or loaded on the processing circuit 2902 and executed by the one or more processors 2904, contribute to a run-time image 2914 that controls the operation of the one or more processors 2904. When executed, certain instructions may cause the processing circuit 2902 to perform functions in accordance with certain methods, algorithms and processes described herein.

Some of the software modules 2916 may be loaded during initialization of the processing circuit 2902, and these software modules 2916 may configure the processing circuit 2902 to enable performance of the various functions disclosed herein. For example, some software modules 2916 may configure internal devices and/or logic circuits 2922 of the processor 2904, and may manage access to external devices such as the transceiver 2912, the bus interface 2908, the user interface 2918, timers, mathematical coprocessors, and so on. The software modules 2916 may include a control program and/or an operating system that interacts with interrupt handlers and device drivers, and that controls access to various resources provided by the processing circuit 2902. The resources may include memory, processing time, access to the transceiver 2912, the user interface 2918, and so on.

One or more processors 2904 of the processing circuit 2902 may be multifunctional, whereby some of the software modules 2916 are loaded and configured to perform different functions or different instances of the same function. The one or more processors 2904 may additionally be adapted to manage background tasks initiated in response to inputs from the user interface 2918, the transceiver 2912, and device drivers, for example. To support the performance of multiple functions, the one or more processors 2904 may be configured to provide a multitasking environment, whereby each of a plurality of functions is implemented as a set of tasks serviced by the one or more processors 2904 as needed or desired. In one example, the multitasking environment may be implemented using a timesharing program 2920 that passes control of a processor 2904 between different tasks, whereby each task returns control of the one or more processors 2904 to the timesharing program 2920 upon completion of any outstanding operations and/or in response to an input such as an interrupt. When a task has control of the one or more processors 2904, the processing circuit is effectively specialized for the purposes addressed by the function associated with the controlling task. The timesharing program 2920 may include an operating system, a main loop that transfers control on a round-robin basis, a function that allocates control of the one or more processors 2904 in accordance with a prioritization of the functions, and/or an interrupt driven main loop that responds to external events by providing control of the one or more processors 2904 to a handling function.

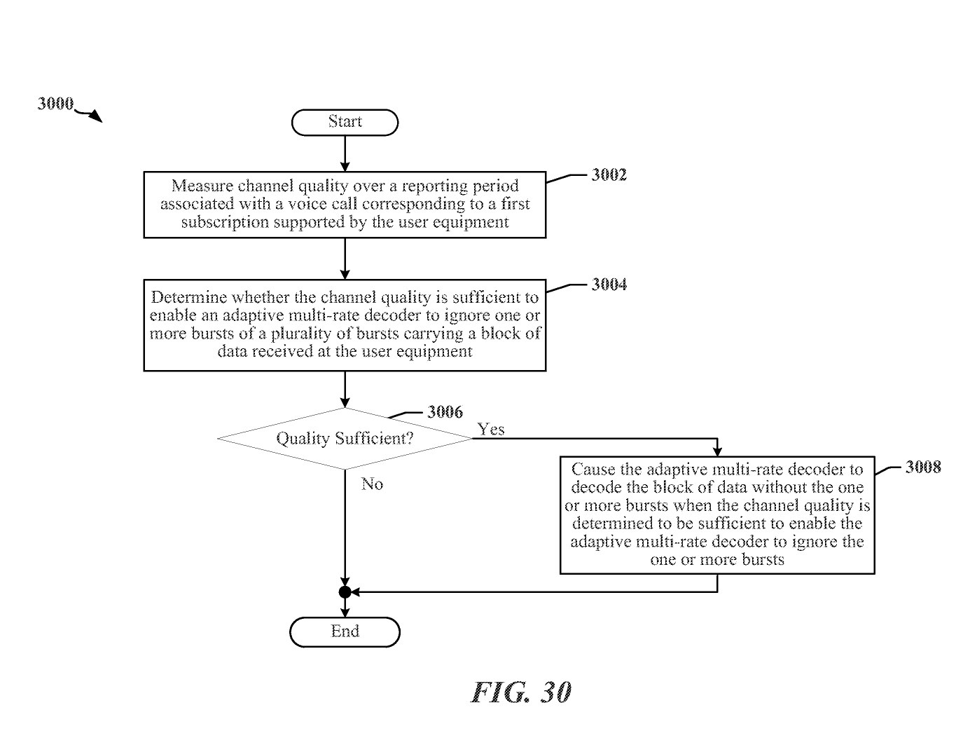

FIG. 30 is a flow chart 3000 of a method of wireless communication. The method may be performed by a UE.

At block 3002, the UE may measure or obtain a measurement of channel quality over a measurement period associated with a voice call corresponding to a first subscription supported by the user equipment. The channel quality may be obtained by measuring a bit error rate for a transmission on a SACCH. The transmission on the SACCH may include one or more signaling messages. The bit error rate may be expressed as an average bit error rate. The channel quality may include a lowest channel quality for a predetermined number of blocks transmitted during the measurement period.

At block 3004, the UE may determine whether the channel quality is sufficient to enable an adaptive multi-rate decoder to ignore one or more bursts of a plurality of bursts carrying a block of data received at the user equipment.

At block 3006, the UE may select a next action based on the determination of channel quality obtained in block 3004. If the channel quality is determined to be insufficient for partial decode, the method ends. If the channel quality is determined to be sufficient for partial decode, the n the UE continues at block 3008

At block 3008, the UE may cause the adaptive multi-rate decoder to decode the block of data without the one or more bursts when the channel quality is determined to be sufficient to enable the adaptive multi-rate decoder to ignore the one or more bursts. The block of data may be decoded without the one or more bursts when it has been determined that the minimum channel quality during the measurement period exceeds a predefined minimum quality, and that receive power associated with the voice call exceeds a predefined minimum power level.

In some instances, one of the plurality of bursts that is received may fail a CRC, and the adaptive multi-rate decoder may include the one or more bursts while decoding the block of data.

In one example, it may be determined that a SNR associated with a first portion of the plurality of bursts exceeds a predefined minimum threshold, and the UE may cause a decoder, which may be a codec, to refrain from receiving a second portion of the plurality of bursts when the SNR exceeds the predefined minimum threshold. An adaptive multi-rate decoder may ignore the one or more bursts for the purpose of decoding the block of data when the minimum channel quality exceeds the predefined minimum quality and the receive power exceeds the predefined minimum power level. The codec may be selected for decoding the block of data from a set of available codecs based on the SNR. A mode of operation of the codec used for decoding the block of data may be selected based on the SNR. The number of bursts in the second portion of the plurality of bursts may be selected based on the SNR.

In another example, the SNR associated with a first portion of the plurality of bursts exceeds a predefined minimum threshold, and the SNR may be used to index a table maintained by the user equipment in order to select a number of bursts to be included in the one or more bursts. The block of data is decoded using a codec, and a characteristic of the codec may be used to select the number of bursts to be included in the one or more bursts.

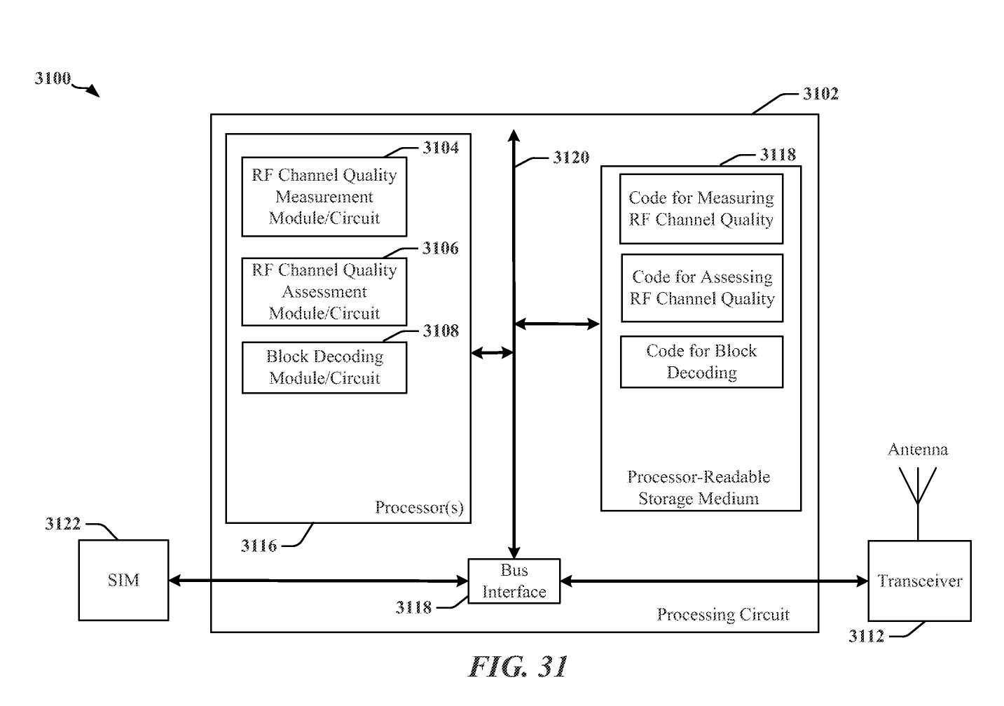

FIG. 31 is a diagram 3100 illustrating a simplified example of a hardware implementation for an apparatus employing a processing circuit 3102. The processing circuit typically has a processor 3116 that may include one or more of a microprocessor, microcontroller, digital signal processor, a sequencer and a state machine. The processing circuit 3102 may be implemented with a bus architecture, represented generally by the bus 3120. The bus 3120 may include any number of interconnecting buses and bridges depending on the specific application of the processing circuit 3102 and the overall design constraints. The bus 3120 links together various circuits including one or more processors and/or hardware modules, represented by the processor 3116, the modules or circuits 3104, 3106 and 3108, one or more transceivers 3112 configurable to communicate over connectors or wires 3114, one or more SIMs 3122, and the computer-readable storage medium 3118. The bus 3120 may include one or more bus interfaces 3118 that can provide access to external or internal components 3112, 3122. The bus 3120 may also link various other circuits such as timing sources, peripherals, voltage regulators, and power management circuits, which are well known in the art, and therefore, will not be described any further.

The processor 3116 is responsible for general processing, including the execution of software stored on the computer-readable storage medium 3118. The software, when executed by the processor 3116, causes the processing circuit 3102 to perform the various functions described supra for any particular apparatus. The computer-readable storage medium 3118 may also be used for storing data that is manipulated by the processor 3116 when executing software, including data decoded from symbols transmitted over the connectors 3114, which may be configured as data lanes and clock lanes. The processing circuit 3102 further includes at least one of the modules 3104, 3106 and 3108. The modules 3104, 3106 and 3108 may be software modules running in the processor 3116, resident/stored in the computer readable storage medium 3118, one or more hardware modules coupled to the processor 3116, or some combination thereof. The modules 3104, 3106 and/or 3108 may include microcontroller instructions, state machine configuration parameters, or some combination thereof.

In one configuration, the apparatus 3100 for wireless communication includes a module and/or circuit 3104 that is configured to measure quality of an RF channel, a module and/or circuit 3106 configured to assess the quality of the RF channel in order to determine whether AMR-PD can be performed, and a module and/or circuit 3108 configured to decode blocks of data received from the RF channel.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the drawings may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the drawings may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: at least one of a; at least one of b; at least one of c; at least one of a and at least one of b; at least one of a and at least one of c; at least one of b and at least one of c; and at least one of a, at least one of b and at least one of c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication at a user equipment, comprising:
measuring channel quality over a measurement period associated with a voice call corresponding to a first subscription supported by the user equipment;
determining whether the channel quality is sufficient to enable an adaptive multi-rate decoder to ignore one or more bursts of a plurality of bursts carrying a block of data received at the user equipment; and
causing the adaptive multi-rate decoder to decode the block of data without the one or more bursts when the channel quality is determined to be sufficient to enable the adaptive multi-rate decoder to ignore the one or more bursts.

2. The method of claim 1, wherein measuring channel quality comprises:
measuring a bit error rate for a transmission on a slow associated control channel (SACCH).

3. The method of claim 2, wherein the transmission on the SACCH comprises one or more signaling messages.

4. The method of claim 2, wherein the bit error rate is expressed as an average bit error rate.

5. The method of claim 2, wherein measuring the channel quality comprises:
determining a lowest channel quality for a predetermined number of blocks transmitted during the measurement period.

6. The method of claim 1, wherein decoding the block of data without using the one or more bursts comprises:
determining whether minimum channel quality during the measurement period exceeds a predefined minimum quality;
establishing whether receive power associated with the voice call exceeds a predefined minimum power level; and
ignoring the one or more bursts when the minimum channel quality exceeds the predefined minimum quality and the receive power exceeds the predefined minimum power level.

7. The method of claim 1, further comprising:
causing the adaptive multi-rate decoder to include the one or more bursts while decoding the block of data when a received one of the plurality of bursts fails a cyclic redundancy check.

8. The method of claim 1, further comprising:
determining that a signal-to-noise ratio (SNR) associated with a first portion of the plurality of bursts exceeds a predefined minimum threshold; and
refraining from receiving a second portion of the plurality of bursts when the SNR exceeds the predefined minimum threshold.

9. The method of claim 8, further comprising:
selecting a codec for decoding the block of data from a set of available codecs based on the SNR.

10. The method of claim 8, further comprising:
selecting a mode of operation of a codec used for decoding the block of data based on the SNR.

11. The method of claim 8, further comprising:
selecting a number of bursts in the second portion of the plurality of bursts based on the SNR.

12. The method of claim 1, further comprising:
determining that a signal-to-noise ratio (SNR) associated with a first portion of the plurality of bursts exceeds a predefined minimum threshold; and
using the SNR to index a table maintained by the user equipment in order to select a number of bursts to be included in the one or more bursts.

13. The method of claim 12, wherein the block of data is decoded using a codec, and further comprising:
using a characteristic of the codec to select the number of bursts to be included in the one or more bursts.

14. A user equipment, comprising:
a transceiver configured to communicate over a radio frequency (RF) channel;
one or more subscriber identity modules (SIMs), wherein the user equipment is adapted to support a dual SIM dual active (DSDA) mode of operation;
an adaptive multi-rate decoder; and
at least one processing circuit configured to:
measure channel quality over a measurement period associated with a voice call corresponding to a first subscription supported by the user equipment, and
determine whether the channel quality is sufficient to enable the adaptive multi-rate decoder to ignore one or more bursts of a plurality of bursts carrying a block of data received at the user equipment,
wherein the adaptive multi-rate decoder is adapted to decode the block of data without the one or more bursts when the channel quality is determined to be sufficient to enable the adaptive multi-rate decoder to ignore the one or more bursts.

15. The user equipment of claim 14, wherein the at least one processing circuit is configured to:
measure the channel quality as a bit error rate for a transmission on a slow associated control channel (SACCH).

16. The user equipment of claim 15, wherein the transmission on the SACCH comprises one or more signaling messages.

17. The user equipment of claim 15, wherein the bit error rate is expressed as an average bit error rate.

18. The user equipment of claim 15, wherein the least one processing circuit is configured to:
determine a lowest channel quality for a predetermined number of blocks transmitted during the measurement period.

19. The user equipment of claim 14, wherein the at least one processing circuit is configured to:
determine whether minimum channel quality during the measurement period exceeds a predefined minimum quality; and
establish whether receive power associated with the voice call exceeds a predefined minimum power level,
wherein the adaptive multi-rate decoder ignores the one or more bursts while decoding the block of data when the minimum channel quality exceeds the predefined minimum quality and the receive power exceeds the predefined minimum power level.

20. The user equipment of claim 14, wherein the adaptive multi-rate decoder includes the one or more bursts while decoding the block of data when a received one of the plurality of bursts fails a cyclic redundancy check.

21. The user equipment of claim 14, wherein the at least one processing circuit is configured to:
determine that a signal-to-noise ratio (SNR) associated with a first portion of the plurality of bursts exceeds a predefined minimum threshold; and
refrain from receiving a second portion of the plurality of bursts when the SNR exceeds the predefined minimum threshold.

22. The user equipment of claim 21, wherein the at least one processing circuit is configured to:
select a codec for decoding the block of data from a set of available codecs based on the SNR.

23. The user equipment of claim 21, wherein the at least one processing circuit is configured to:
configure a mode of operation of a codec used for decoding the block of data based on the SNR.

24. The user equipment of claim 21, wherein the at least one processing circuit is configured to:
select a number of bursts in the second portion of the plurality of bursts based on the SNR.

25. The user equipment of claim 14, wherein the at least one processing circuit is configured to:
determine that a signal-to-noise ratio (SNR) associated with a first portion of the plurality of bursts exceeds a predefined minimum threshold; and
use the SNR to index a table maintained by the user equipment in order to select a number of bursts to be included in the one or more bursts.

26. The user equipment of claim 25, further comprising:
a codec adapted to decode the block of data,
wherein the at least one processing circuit is configured to select the number of bursts to be included in the one or more bursts based on a characteristic of the codec.

27. An apparatus, comprising:
a transceiver configured to communicate over a radio frequency (RF) channel;
one or more subscriber identity modules (SIMs);
means for measuring RF channel quality during a measurement period associated with a voice call corresponding to a first subscription supported by the apparatus;
means for determining whether the RF channel quality is sufficient to enable an adaptive multi-rate decoder to ignore one or more bursts of a plurality of bursts carrying a block of data received at the apparatus; and
means for decoding the block of data including an adaptive multi-rate decoder that is configured to decode the block of data without the one or more bursts when the channel quality is determined to be sufficient to enable the adaptive multi-rate decoder to ignore the one or more bursts.

28. The apparatus of claim 27, wherein the means for decoding the block of data is configured to:
determine whether minimum channel quality during the measurement period exceeds a predefined minimum quality;
establishing whether receive power associated with the voice call exceeds a predefined minimum power level; and
ignore the one or more bursts when the minimum channel quality exceeds the predefined minimum quality and the receive power exceeds the predefined minimum power level.

29. A computer-readable medium storing instructions, wherein the instructions when executed by a processing circuit cause the processing circuit to:
measure channel quality over a measurement period associated with a voice call corresponding to a first subscription supported by a user equipment;
determine whether the channel quality is sufficient to enable an adaptive multi-rate decoder to ignore one or more bursts of a plurality of bursts carrying a block of data received at the user equipment; and
cause the adaptive multi-rate decoder to decode the block of data without the one or more bursts when the channel quality is determined to be sufficient to enable the adaptive multi-rate decoder to ignore the one or more bursts.

30. The computer-readable medium of claim 29, wherein the instructions cause the processing circuit to:
determine whether minimum channel quality during the measurement period exceeds a predefined minimum quality;
establish whether receive power associated with the voice call exceeds a predefined minimum power level; and
ignore the one or more bursts when the minimum channel quality exceeds the predefined minimum quality and the receive power exceeds the predefined minimum power level.
